(19) United States
(12) Patent Application Publication
(10) Pub. No.: US 2010/0066378 A1
(43) Pub. Date: Mar. 18, 2010

(54) Current Mirror Potentiostat

(75) Inventors: Mohammad Mahdi Ahmadi, Toronto (CA); Graham Arnold Jullien, Tecumseh (CA)

Correspondence Address: FULBRIGHT & JAWORSKI L.L.P., 600 CONGRESS AVE., SUITE 2400, AUSTIN, TX, 78701, US

(73) Assignee: UTI LIMITED PARTNERSHIP, Calgary (CA)

(21) Appl. No.: 12/562,459

(22) Filed: Sep. 18, 2009

Related U.S. Application Data
(60) Provisional application No. 61/098,178, filed on Sep. 18, 2008.

(51) Int. Cl. G01N 27/416

(52) U.S. Cl. 324/429

(57) ABSTRACT

Systems, methods, and apparatuses for measuring current flow in an electrochemical cell are disclosed. A system includes a circuit configured to output a mirrored value of an electrical current flowing through an electrochemical cell. The system may also include a voltage controller, coupled to one or more electrodes of the electrochemical cell, for controlling the voltage difference between at least two electrodes of the electrochemical cell. The system may further include a current replication circuit coupled to the voltage controller or the electrochemical cell. The current replication circuit generates a mirrored current of the electrical current flowing in the electrochemical cell. The replicated current may be measured or processed with different circuits and methods to output the current flowing through the electrochemical cell.

### CROSS-REFERENCE TO RELATED APPLICATIONS

This application claims the benefit of U.S. Provisional Application No. 61/098,178 filed Sep. 18, 2008, the entire contents of which is specifically incorporated herein by reference without disclaimer.

### TECHNICAL FIELD

This disclosure generally relates to electronic circuitry, and in particular, electronic circuits for electrochemical sensors.

### BACKGROUND

Amperometric electrochemical sensors can be used for many purposes, such as the food industry, environmental monitoring, and biotechnology. In general, such sensors can be used to provide an electronic feedback mechanism for monitoring a selected parameter, such as an oxygen concentration. These sensors can provide good sensitivity and selectivity for detecting different chemical and biological species such as oxygen, glucose, and toxic metals, for example. Generally, an amperometric electrochemical sensor generates an electrical current in response to the presence of a chemical or biological species, and, in some cases, the current is proportional (or a proportion can be calculated) to the concentration of that species. An amperometric electrochemical sensor can include an electrode system that can be placed in contact with the chemical or biological species. A potentiostat can be used to monitor the electrical signals generated at the electro-active surface of the sensor. In some cases, the potentiostat can produce an electrical signal proportional to the concentration of the chemical species.

In its simplest form, an electrochemical sensor can include two electrodes: a working (or sensing, or indicator) electrode, on which electrochemical reaction takes place, and a reference (or probe) electrode, which can be used to measured the solution potential. The electrodes on an electrochemical sensor can be immersed in a solution. The combination of the immersed electrodes in the solution and the solution itself can be called an electrochemical cell. Electrochemical cells that include only reference and working electrode are called two-electrode cells.

In some cases, it may be beneficial to have a predetermined voltage or potential between the working and reference electrodes of an electrochemical cell. A potentiostat is an electronic instrument which controls the voltage or potential difference between the working electrode and the reference electrode of for example, an electrochemical cell. The potentiostat can control the potential difference by injecting an electric current into the electrochemical cell. Generally, the potentiostat can measure the electric current flowing in the working electrode. That is, the potentiostat measures the electrochemical activity caused by certain reactions at the surface of the electrodes of the electrochemical cell. The current flowing from the working electrode into the electrochemical cell may be referred to as sensor current I_{F} or cell current.

Precise control of the interfacial potential difference at the interface between working electrode and solution may be beneficial in many electrochemical experiments, but may not be generally possible with a two-electrode cell because the solution has some resistance. The resistance generates a potential drop across the cell when an electric current flows through the cell. Also, when an electric current flows through the reference electrode, the reference electrode can become slightly polarized, causing some changes in its interfacial potential difference. As a result, the interfacial potential difference of the working electrode may not be precisely controlled in a two-electrode system.

Recently, there has been a growing interest in using electrochemical sensors because of the high sensitivity and selectivity that they provide. In many cases, it may be desirable for a potentiostat connected to an electrochemical sensor to consume very low power, consume very small chip area, and function with low supply voltages. For example, electrochemical sensors have been used in portable electronic devices to detect toxic metals in natural waters. Another example is implantable devices used to monitor internal biological species such as glucose, oxygen, and cholesterol. In such devices, it is desirable that the electronic instrument in the portable device (1) consumes very low power in order to extend the battery lifetime of the portable device, (2) functions with low supply voltages at or below 1.5 V, (3) be fabricated with small cost (for example it should consume small chip area, (4) have low noise allowing measurement of very small electrochemical activities. Thus, there is a need for a potentiostat having some of the characteristics described above.

### SUMMARY

According to one aspect of the disclosure, a circuit for measuring an electrical current in an electrochemical cell includes a voltage controller coupled to said electrochemical cell that controls a voltage difference between at least two electrodes of said electrochemical cell. The circuit also includes a current copier coupled to at least one of said voltage controller and said electrochemical cell that produces a mirrored current of said electrical current. The circuit further includes a current measurer coupled to said current copier that measures said mirrored current.

According to another aspect of the disclosure, a method for measuring current in an electrochemical cell includes applying a constant potential to a working electrode and a reference electrode of said electrochemical cell to induce an electrical current through said electrochemical cell. The method also includes replicating said electrical current to produce a mirrored electrical current. The method further includes measuring said mirrored electrical current.

According to a further aspect of the disclosure, a potentiostat includes means for controlling voltage coupled to an electrochemical cell that generates an electrical current through said electrochemical cell. The potentiostat also includes means for generating a mirrored current of said electrical current for measurement without disturbing said electrical current.

The term “coupled” is defined as connected, although not necessarily directly, and not necessarily mechanically.

The teens “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### DESCRIPTION OF DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a circuit schematic illustrating an exemplary portable monitoring device that includes an amperometric electrochemical sensor according to one embodiment.

FIG. 1B is a circuit schematic illustrating a potentiostat according to one embodiment.

FIG. 2A is a circuit schematic illustrating an exemplary potentiostat having current replication using a current mirror according to one embodiment.

FIG. 2B is a circuit schematic illustrating an exemplary potentiostat having current replication using a current mirror according to one embodiment.

FIG. 3 is a circuit schematic illustrating an exemplary potentiostat having current replication using multiple current mirrors according to one embodiment.

FIG. 4 is a circuit schematic illustrating an exemplary potentiostat having current replication using a cascode current mirror according to one embodiment.

FIG. 5 is a circuit schematic illustrating an exemplary potentiostat having bipolar transistor technology according to one embodiment.

FIG. 6 is a circuit schematic illustrating an exemplary potentiostat having current replication with increased gain according to one embodiment.

FIG. 7 is a circuit schematic illustrating an exemplary potentiostat having a current-to-frequency converter according to one embodiment.

FIG. 8A is a circuit schematic illustrating an exemplary small-signal model of a potential control loop according to one embodiment.

FIG. 8B is a circuit schematic illustrating an exemplary potential control loop having a feedforward signal path according to one embodiment.

FIG. 8C is a circuit schematic illustrating an exemplary transistor level potentiostat circuit according to one embodiment.

FIG. 9 is a flow chart illustrating an exemplary method for controlling and replicating current through an electrochemical cell according to one embodiment.

FIG. 10 is a flow chart of an exemplary method for determining the concentration of an analyte in a chemical species using a monitoring device that includes an amperometric electrochemical sensor according to one embodiment.

FIG. 11 is a block diagram illustrating an exemplary potentiostat according to one embodiment.

FIG. 12 is a block diagram illustrating an exemplary potentiostat according to one embodiment.

FIG. 13 is a circuit schematic illustrating an exemplary potentiostat used for electrochemical sensors for which the sensor current is a result of a reduction reaction at the surface of the working electrode according to one embodiment.

FIG. 14 is a circuit schematic illustrating an exemplary potentiostat used for electrochemical sensors for which the sensor current is a result of a reduction reaction at the surface of the working electrode according to one embodiment.

FIG. 15 is a circuit diagram illustrating an exemplary potentiostat used for electrochemical sensors for which the sensor current is the result of an oxidation reaction at the surface of the working electrode according to one embodiment.

FIG. 16 is a circuit diagram illustrating an exemplary potentiostat used for electrochemical sensors for which the sensor current is the result of an oxidation reaction at the surface of the working electrode according to one embodiment.

FIG. 17 a circuit diagram illustrating an exemplary potentiostat having cascode transistors used for electrochemical sensors for which the sensor current is the result of an oxidation reaction at the surface of a working electrode according to one embodiment

FIG. 18 a circuit diagram illustrating an exemplary potentiostat having a regulated cascode current copier to reduce current mismatch according to one embodiment

FIG. 19 is a circuit diagram illustrating an exemplary potentiostat circuit used for electrochemical sensors for which the sensor current is the result of an oxidation reaction at the surface of the working electrode according to one embodiment

FIG. 20 is a circuit diagram illustrating an exemplary potentiostat used for electrochemical sensors for which the sensor current is the result of an oxidation reaction at the surface of the working electrode according to one embodiment

FIG. 21 is a circuit diagram illustrating an exemplary potentiostat coupled to electrochemical sensors with oxidation current and electrochemical sensors with reduction current according to one embodiment.

### DETAILED DESCRIPTION

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

A three-electrode electrochemical cell, can be used in which improved potential control can be achieved by introducing a new electrode into the electrochemical cell called the counter (or auxiliary) electrode. In a three-electrode electrochemical cell, the potentiostat injects the electric current into the cell via the counter electrode. Therefore, since much smaller electric current flows through the reference electrode, the interfacial potential difference at the reference electrode does not change, resulting in a better control of the interfacial potential difference at the working electrode.

The foregoing detailed descriptions of various implementations disclose a potentiostat which consumes low power, operates with very low supply voltages, occupies very small chip area, and possess low noise. The disclosed potentiostat may connect to three-electrode electrochemical cells or two-electrode electrochemical cells.

Some sensing or monitoring devices can use amperometric electrochemical sensors to detect the presence of a given material or compound. For example, a portable monitoring device can use an amperometric electrochemical sensor to detect toxic metals in natural waters. In another example, a portable, implantable monitoring device can utilize an amperometric electrochemical sensor to monitor the concentration of biological species (e.g., oxygen, glucose or cholesterol) in human blood. In some cases, portable monitoring devices may include integrated circuits, that advantageously function with low power requirements.

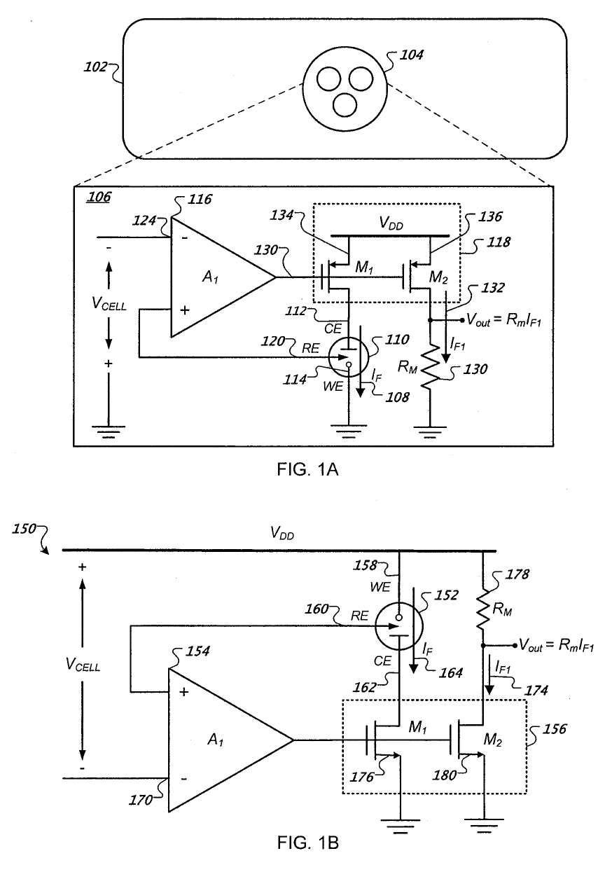

Referring now to FIG. 1A, a portable monitoring device 102 includes an amperometric electrochemical sensor 104 having a potentiostat circuit 106 including an electrochemical cell 110, an amplifier 116, and a current mirror 118. The potentiostat circuit 106 controls the voltage difference between a working electrode 114 and a reference electrode 120 of the electrochemical cell 110 by sinking a current into the electrochemical cell 110 through a counter electrode 112. The potentiostat circuit 106 also measures the sensor current 108, I_{F}, flowing through the electrochemical cell 110. In one embodiment, the direction of the sensor current 108, I_{F}, through the electrochemical cell 110 is from the counter electrode 112 to the working electrode 114.

In some embodiments, the electrochemical cell 110 may be immersed in an electrolytic solution. For example, the buildup of charge that occurs at the working electrode 114 and the solution may cause an interfacial potential difference affecting the rate and direction of the chemical reaction in the solution. Control of the reaction rate at the working electrode 114 surface may be accomplished by manipulating the potential difference at the interface. The reaction rate may be measured by monitoring the sensor current 108, I_{F}, flowing through the working electrode 114. The sensor 104 may be used to control the reaction rate and measure the interfacial potential difference at the working electrode 114.

The working electrode 114 is maintained at a ground potential and the amplifier 116 controls the sensor current 108, I_{F}, such that a cell potential, V_{CELL}, measured between an inverting input 124 of the amplifier 116 and ground, is maintained at a desired voltage level. In this embodiment, the sensor current, I_{F}, 108 flows from the counter electrode 112 to the working electrode 114.

In some embodiments of the sensor 104, the counter electrode 112 may control, through grounding, the potential difference between the working electrode 114 and the reference electrode 120. For example, the counter electrode 112 may be maintained at ground and the amplifier 116 may control the sensor current 108, I_{F}, such that a cell potential, measured with respect to a positive voltage level and the inverting input 124 of the amplifier 116, is maintained at a desired value. In this embodiment, the sensor current 108, I_{F}, flows through the working electrode 114 to the counter electrode 112.

The potentiostat circuit 106 controls the sensor current 108, I_{F}, flowing through the counter electrode 112 and the working electrode 114. In some embodiments, the sensor current 108, I_{F}, may be controlled by using a feedback loop, which injects an appropriate amount of current into the counter electrode 112 to maintain the potential difference between the working electrode 114 and the reference electrode 120 at a desired potential.

The amplifier 116 may control a voltage difference between the working electrode 114 and the reference electrode 120 in the electrochemical cell 110. In some embodiments, the voltage may be controlled by adjusting the sensor current 108, I_{F}, flowing through the counter electrode 112 and the working electrode 114 while preventing any current from flowing through the reference electrode 120. Reducing current flow through the reference electrode 120 reduces the likelihood of change in interfacial potential difference at the reference electrode 120 allowing better control of the interfacial potential difference at the working electrode 114.

The potentiostat circuit 106 measures the sensor current 108, I_{F}, flowing through the electrochemical cell 110 by incorporating a current measuring circuit in the path of the sensor current 108, I_{F}. In some embodiments, the current measuring circuit is incorporated between the working electrode 114 and ground. In one exemplary embodiment, the current measuring circuit includes a transimpedance amplifier, which introduces a virtual ground at the working electrode 114, while generating an output voltage proportional to the sensor current 108, I_{F}.

For example, the current measuring circuit may include a resistor incorporated between the working electrode 114 and ground. In this example, the potential of the working electrode 114 will change depending on the sensor current 108, I_{F}, flowing through the resistor. Therefore, the current measuring circuit may also measure this potential and feed it back to the amplifier 116 for proper control of the sensor current 108, I_{F}. In yet another example, the current measuring circuit may be a resistor incorporated between the counter electrode 112 and an output 130 of the amplifier 116. In this example, the current measuring circuit also includes an instrumentation amplifier to measure the voltage generated across the resistor, which is proportional to the sensor current 108, I_{F}.

In some embodiments, the integrity of a potentiostat circuit can be improved by the incorporation of a current measuring circuit outside the path of the sensor current 108, I_{F}. The potentiostat circuit 106 reduces the likelihood of deleterious circuit effects, such as noise and instability, and decreases current consumption of the circuit. This is particularly desirable in systems requiring low power consumption.

In one embodiment, a circuit may be placed in the path of the sensor current that generates a copy of the sensor current. The copy of the sensor current may be measured using various types of measurement circuitry. In such embodiments, performing a measurement of the sensor current copy reduces the likelihood that the integrity of the sensor current is compromised.

A current mirror 118 is placed between a supply voltage, V_{DD}, and the counter electrode 112 in the path of the sensor current 108, I_{F}. The current mirror 118 mirrors (e.g., “copies”) the sensor current 108, I_{F}, flowing through the counter electrode 112 and the working electrode 114 by generating a mirrored sensor current 132, I_{F1}. The amplifier 116 and a transistor 134 create a feedback loop, through which the potential of the reference electrode 120 is stabilized at the desired cell potential, V_{CELL}. The transistor 134 is a common-source stage for a second stage of amplification, and the amplifier 116 provides the first stage.

In some embodiments, the potentiostat circuit 106 is part of an integrated circuit. In such embodiments, transistors 134, 136 are matched (e.g., the transistor 136 has the same gate-to-source potential as the transistor 134). The transistor 136 mirrors the current flowing through the transistor 134. To reduce the likelihood of current mismatch between the transistors 134, 136, the channel length of transistors 134, 136 may be increased. Alternatively, advanced current mirror circuits (e.g., cascode current mirror circuits and regulated cascode (gain-boosted) current mirror circuits) may be used.

A potential control loop of the potentiostat circuit 106 includes the amplifier 116 as well as the transistor 134. Addition of the transistor 134 in the potential control loop results in the addition of another gain stage to the potential control loop. This can be the equivalent of using a two-stage amplifier for the potential control loop. The load of the transistor 134 may vary along with the bias current of the transistor 134. In some embodiments, the measured sensor current is small (e.g., between 1 nA. and 1 μA.). The transistor 134 bias current may vary in the same range as the sensor current (e.g., within three orders of magnitude).

A current measurement resistor 130 may be incorporated in the path of the mirrored sensor current 132, I_{F1}. A voltage, V_{out,}across the resistor 130 is related to the mirrored sensor current 132, I_{F1}, according to the equation: Vₒᵤₜ=R_{M}*I_{F1}. Thus, the voltage is related to the sensor current 108, I_{F}, flowing through the electrochemical cell 110. In one embodiment, the voltage, Vₒᵤₜ, may be measured using an analog-to-digital converter (ADC) (not shown).

The potentiostat circuit 106 circuit noise, instability, and other undesirable effects in the sensor 104. Additionally, the potentiostat circuit 106 consumes little power because of the few number of active and passive components. Further, coupling the working electrode 114 to ground reduces circuit noise and interference pick-up. The current mirror 118 increases current consumption of the potentiostat circuit 106 by the mirrored sensor current 132, I_{F1}. However, the mirrored sensor current 132, I_{F1}, is small (e.g., 1 nA. to 1 μA.).

In some embodiments, the headroom for voltage swing at the counter electrode 112 remains unaffected as the resistor 130 is placed in the path of a mirrored sensor current 132, I_{F1}, and not in the path of the sensor current 108, I_{F}. In some embodiments, changing the resistor 130 to a larger resistance value allows accurate measurement of a small sensor current 108, I_{F}, without affecting the stability of the potential control loop. For example, the potential control loop of the potentiostat circuit 106 includes the amplifier 116 as well as the transistor 134. Addition of the transistor 134 in the potential control loop adds another gain stage to the potential control loop (e.g., a two-stage amplifier).

In some embodiments, the mirrored sensor current 132, I_{F1}, may be converted to a digital value using an ADC (not shown). The digital output of ADC may be correlated to the sensor current 108, I_{F}, as the mirrored sensor current 132, I_{F1}, is a copy of the sensor current 108, I_{F}. In some embodiments, the mirrored sensor current 132, I_{F1}, is converted to a frequency-modulated pulse waveform where the time difference between two consecutive pulses is inversely proportional to the mirrored sensor current 132, I_{F1}. Therefore, the measured time difference may be related to the sensor current 108, I_{F}, flowing through the electrochemical cell 110, as the mirrored sensor current 132, I_{F1}, is a mirrored version (or copy) of the sensor current 108, I_{F1}.

In one embodiment, the potentiostat circuit 106 is incorporated into a glucose biosensor. The electrochemical cell 110 may be an oxygen electrode-based (O₂-based) glucose biosensor. In oxygen electrode-based glucose biosensors, a cell potential, V_{CELL}, may range from about −0.6 V to −0.9 V (with reference to a standard Ag/AgCl reference electrode during measurement. The sensor current 108, I_{F}, may be the result of the reduction of oxygen at the surface of the working electrode 114. The reference electrode 120 may be maintained at a potential of about 0.6 V to 0.9 V above the potential of the working electrode 114. The direction of the sensor current, 108, I_{F}, may be from the counter electrode 112 to the working electrode 114. The potentiostat circuit 106 accommodates an oxygen electrode-based glucose biosensor in a single supply voltage circuit for use in an electrochemical reduction process.

Turning now to FIG. 1B, a potentiostat circuit 150 may be used to measure parameters of an electrochemical oxidation process according to one embodiment. The potentiostat circuit 150 includes an electrochemical cell 152, a control amplifier 154, and a current mirror 156. The potentiostat circuit 150 controls the voltage difference between a working electrode 158 and a reference electrode 160 of the electrochemical cell 152 by sourcing a current through the a counter electrode 162. The potentiostat circuit 150 also measures the sensor current 164, I_{F}, flowing through the electrochemical cell 152.

The working electrode 158 may be coupled to a supply voltage, V_{DD}, which controls the potential difference between the working electrode 158 and the reference electrode 160 in the electrochemical cell 152. In one embodiment, the working electrode 158 is maintained at a positive voltage potential, and the control amplifier 154 controls the sensor current 164, I_{F}, such that a cell potential, V_{CELL}, measured between the supply voltage, V_{DD}, and an inverting input 170 of the control amplifier 154 is maintained at a desired voltage level. In this example, sensor current 164, I_{F}, flows from the working electrode 158 to the counter electrode 162.

In another embodiment, the potentiostat circuit 150 controls the sensor current 164, I_{F}, flowing between the working electrode 158 and the counter electrode 162 by using a feedback loop. The feedback loop sinks an amount of current from the counter electrode 162 to maintain the potential difference between the working electrode 158 and the reference electrode 160 at a desired potential. The control amplifier 154 controls a voltage difference between the working electrode 158 and the reference electrode 160 in the electrochemical cell 152 by adjusting the sensor current 164, I_{F}, flowing through the working electrode 158 and the counter electrode 162 while preventing any current from flowing through the reference electrode 160. Reducing current flow through the reference electrode 160 maintains the interfacial potential difference at the reference electrode 160. Thus, better control of the interfacial potential difference at the working electrode 158 is gained.

In some embodiments, the sensor current 164, I_{F}, flowing through the electrochemical cell 152 is measured, for example, by placing a current measuring circuit (e.g., the current mirror 156 and a current measurement resistor 178) in the path of the sensor current 164, I_{F}. In other embodiments, the current measuring circuit is placed between the counter electrode 162 and ground.

The current mirror 156 is placed between the counter electrode 162 and ground in the path of the sensor current 164, I_{F}. The current mirror 156 mirrors the sensor current 164, I_{F}, flowing through the working electrode 158 and the counter electrode 162 by generating a mirrored sensor current 174, I_{F1}. The control amplifier 154 and a transistor 176 create a feedback loop through which the potential of the reference electrode 160 is stabilized at the desired cell potential, V_{CELL}.

In some embodiments, the potentiostat circuit 150 is included in an integrated circuit (IC). In these embodiments, transistors 176, 180 may be matched (e.g., the transistor 176 has the same gate-to-source potential as the transistor 180). The transistor 176 mirrors the current flowing through the transistor 180. To reduce the likelihood of current mismatch between the transistors 176, 180, the channel length of the transistors 176, 180 may be increased. Alternatively, the potentiostat circuit may use advanced current mirror circuits (e.g., cascode circuits and regulated cascode circuits).

A resistor 178 may be integrated into the path of the mirrored sensor current 174, I_{F1}. An output voltage, Vₒᵤₜ, generated across the resistor 178 may be measured and the voltage calculation from the mirrored sensor current 174, I_{F1}, according to: Vₒᵤₜ=R_{M}*I_{F1}. Therefore, the output voltage, Vₒᵤₜ, is related to the sensor current 164, I_{F}, flowing through the electrochemical cell 152. The output voltage, Vₒᵤₜ, may be converted to a digital value by an ADC (not shown).

In some embodiments, the headroom for voltage swing at the counter electrode 162 remains unaffected as the resistor 178 is placed in the path of the mirrored sensor current 174, I_{F1}, and not in the path of the sensor current 164, I_{F}. Additionally, in some embodiments, increasing the resistance value of the resistor 178 allows accurate measurement of a smaller sensor current 164, I_{F}, without affecting the stability of the potential control loop. For example, the potential control loop of the potentiostat circuit 150 includes the control amplifier 154 as well as the transistor 176. Addition of the transistor 176 in the potential control loop results in the addition of another gain stage to the potential control loop creating a two-stage amplifier for the potential control loop.

In some embodiments, the electrochemical cell 152 is a hydrogen peroxide electrode-based (H₂O₂-based) glucose biosensor. In hydrogen peroxide-based glucose biosensors, a cell potential, V_{CELL}, can range from about +0.6 V to +0.8 V (with reference to a reference electrode 160 having a standard Ag/AgCl reference electrode) during measurement. The sensor current 164, I_{F}, is the result of oxidation of hydrogen peroxide at the surface of the working electrode 158. The reference electrode 160 is maintained at a potential of about 0.6 V to 0.8 V below the potential of the working electrode 158. The direction of the sensor current 164, I_{F}, is from the working electrode 158 to the counter electrode 162. The potentiostat circuit 150 accommodates a hydrogen peroxide electrode-based glucose biosensor in a single supply voltage circuit for use in an electrochemical oxidation process.

The potentiostat circuit 150 may be integrated into, for example, a portable monitoring device having an implantable hydrogen peroxide based glucose monitor. In one embodiment, the output voltage, V_{OUT}, is indicative of the oxidation of hydrogen peroxide at the surface of the working electrode. For example, the electrochemical cell 152 may include a platinum working electrode 158, a platinum counter electrode 162, and a silver/silver chloride (Ag/AgCl) reference electrode 160. In this example, the analyte measured at the working electrode 158 is hydrogen peroxide (H₂O₂). Glucose oxidase catalyzes the conversion of oxygen and glucose to hydrogen peroxide and gluconate according to: Glucose+O₂→Gluconate+H₂O₂. Using this equation, the potentiostat circuit 150 monitors the change in the concentration of hydrogen peroxide (H₂O₂) and determines the concentration of glucose in the bloodstream. Oxidation of H₂O₂ by the working electrode 158 may be balanced by the reduction of ambient oxygen, enzyme-generated H₂O₂, or other reducible chemical species at the counter electrode 162. The H₂O₂ produced from the glucose oxidase reaction can further react at the surface of the working electrode 158.

In some embodiments, the potentiostat circuit 150 is included with additional integrated circuits. The integrated circuits may be used in a variety of applications that include, but are limited to, environmental monitoring, the food industry, and biomedical applications. In some embodiments, the integrated circuits are fabricated using CMOS processes. The CMOS circuits reduce power consumption and operate with low power supply voltages, making them attractive for use in battery-operated devices. For example, a continuous blood glucose monitoring device may be implanted into a human body that continuously measures the blood glucose level in the body. The device may transmit the measured data to an external reader/recorder. The continuous blood glucose monitoring device may have low power consumption because the power provided to the device (either by a battery or by an inductive power transfer link) is low.

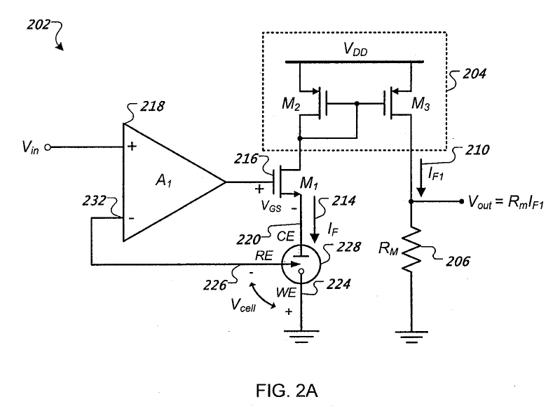

Turning now to FIG. 2A, a potentiostat circuit 202 includes current replication circuitry using a current mirror 204. The potentiostat circuit 202 may be used with an electrochemical cell 228 where a sensor current 214, I_{F}, results from a redox reaction at a working electrode 224.

The potentiostat circuit 202 includes a transistor 216 in a common-drain stage (the voltage follower stage) for the second stage of amplification, where the amplifier 218 provides the first stage. Use of the amplifier 218 and the transistor 216 in a common-drain stage in the potentiostat circuit 202 in a common-drain stage provides improved stability.

The headroom for voltage swing at the counter electrode 220 is reduced by a voltage drop, V_{GS}, of the transistor 216. In some embodiments, the use of CMOS native (zero-threshold voltage) transistors reduces the likelihood of the influence of the voltage drop, V_{GS}, of the transistor 216 in the voltage swing of the counter electrode 220. The voltage drop, V_{GS}, of the transistor 216 may be considered negligible.

In the potentiostat circuit 202, grounding the working electrode 224 controls the potential difference between the working electrode 224 and a reference electrode 226. For example, the working electrode 224 is maintained at ground and the amplifier 218 and the transistor 216 control the sensor current 214, I_{F}, such that a cell potential, V_{CELL}, measured between the reference electrode 226 and the working electrode 224, is maintained at a desired level. The reference electrode 226 may be coupled to an inverting input 232 of the amplifier 218 and the working electrode 224 may be coupled to ground. In this embodiment, the sensor current 214, I_{F}, flows from the counter electrode 220 to the working electrode 224.

The potentiostat circuit 202 controls the sensor current 214, I_{F}, flowing between the counter electrode 220 and the working electrode 224. In some embodiments, sensor current is controlled with a feedback loop, which injects an appropriate amount of current into the counter electrode 220 to maintain the potential difference between the working electrode 224 and the reference electrode 226 at a desired potential.

The amplifier 218 and the transistor 216 control a voltage difference between the working electrode 224 and the reference electrode 226. In some embodiments, the voltage is controlled by adjusting the sensor current 214, I_{F}, flowing between the counter electrode 220 and the working electrode 224 while preventing any current from flowing through the reference electrode 226. Since current flow is substantially reduced through the reference electrode 226, the likelihood of change in the interfacial potential difference at the reference electrode 226 may be reduced resulting in better control of the interfacial potential difference at the working electrode 224.

In some embodiments, the sensor current 214, I_{F}, flowing through the electrochemical cell 228 is measured, for example, by placing the current mirror in the path of the mirrored sensor current 210, I_{F1}. The current mirror 204 may be placed between a supply voltage, V_{DD}, and the gate of transistor 216, in the path of the sensor current 214, I_{F}. The current mirror 204 mirrors the sensor current 214, I_{F}, flowing between the counter electrode 220 and the working electrode 224 by generating a mirrored sensor current 210, I_{F1}. The amplifier 218 and transistor 216 create a feedback loop through which the potential of the reference electrode 226 is stabilized at the desired cell potential, V_{CELL}.

A current measurement resistor 206 may be integrated into the path of the mirrored sensor current 210, I_{F1}. An output voltage, Vₒᵤₜ, generated across the resistor 206 may be measured. The output voltage, Vₐᵤₜ, is related to the mirrored sensor current 210, I_{F1}, according to: Vₒᵤₜ=R_{M}*I_{F1}. Thus, the output voltage, Vₐᵤₜ, may be related to the sensor current 214, I_{F}, flowing through the electrochemical cell 228, as the mirrored sensor current 210, I_{F1}, is a mirrored version (or copy) of the sensor current 214, I_{F}. The output voltage, Vₐᵤₜ, may be converted to a digital value by an ADC (not shown).

Turning now to FIG. 2B, an exemplary potentiostat circuit 250 includes current replication using a current mirror 252. The potentiostat circuit 250 may be used with an electrochemical cell 262 where a sensor current 280, I_{F}, is the result of an oxidation reaction at a working electrode 264. A transistor 266 is configured as a common-drain stage (the voltage follower stage) for the second stage of amplification, where an amplifier 268 provides the first stage. The amplifier 268 and the transistor 266 in the potentiostat circuit 250 provide improved stability in the common-drain stage.

The headroom for voltage swing at a counter electrode 270 is reduced by a voltage drop, V_{GS}, of the transistor 266. In some embodiments, the use of CMOS native (zero-threshold voltage) transistors reduce the likelihood of the influence of the voltage drop, V_{GS}, of the transistor 266 in the voltage swing of the counter electrode 270. The voltage drop, V_{GS}, of the transistor 266 may be considered negligible.

The working electrode 264 is coupled to a supply voltage, V_{DD}, to assist in controlling the potential difference between the working electrode 264 and a reference electrode 274. For example, the working electrode 264 may be maintained at a positive voltage potential and the amplifier 268 and the transistor 266 may control the sensor current 280, I_{F}, such that a cell potential, V_{CELL}, measured between the working electrode 264 and the reference electrode 274 is maintained at a desired voltage level. The reference electrode 274 may be coupled to an inverting input 278 of the amplifier 268, and the working electrode 264 may be coupled to the supply voltage, V_{DD}. In one embodiment, the sensor current 280, I_{F}, flows from the working electrode 264 to the counter electrode 270.

The potentiostat circuit 250 controls the sensor current 280, I_{F}, flowing through the counter electrode 270 and the working electrode 264. In some embodiments, the sensor current 280, I_{F}, is controlled using a feedback loop, which injects an appropriate amount of current into the counter electrode 270 to maintain the potential difference between the working electrode 264 and the reference electrode 274 at a desired potential.

The amplifier 268 and the transistor 266 may control a voltage difference between the working electrode 264 and the reference electrode 274. In some embodiments, the voltage is controlled by adjusting the sensor current 280, I_{F}, flowing through the working electrode 264 and the counter electrode 270, and preventing any current from flowing through the reference electrode 274. Since current flow is substantially reduced through the reference electrode 274 the likelihood of change in the interfacial potential difference at the reference electrode 274 may be reduced, allowing better control of the interfacial potential difference at the working electrode 264.

In some embodiments, the sensor current 280, I_{F}, flowing through the electrochemical cell 262 is measured, for example, by placing the current mirror 252 in the path of the sensor current 280, I_{F}. In some embodiments, the current mirror 252 is placed between a ground and the source of the transistor 266 in the path of the sensor current 280, I_{F}. The current mirror 252 mirrors the sensor current 280, I_{F}, flowing through the working electrode 264 and the counter electrode 270, by generating the mirrored sensor current 258, I_{F1}. The amplifier 268 and the transistor 266 create a feedback loop, through which the potential of the reference electrode 274 is stabilized at the desired cell potential, V_{CELL}.

A current measurement resistor 254 may be integrated into the path of the mirrored sensor current 258, I_{F1}. A voltage, Vₒᵤₜ, generated across the resistor 254 may be measured, where the voltage 260 is related the mirrored sensor current 258, I_{F1}, according to:

Vₒᵤₜ=R_{M}*I_{F1}. The voltage, Vₒᵤₜ, may be related to the sensor current 280, I_{F}, flowing through the electrochemical cell 262, as the mirrored sensor current 258, I_{F1}, is a mirrored version (or copy) of the sensor current 280, I_{F}. The voltage may be converted to a digital value by an ADC (not shown).

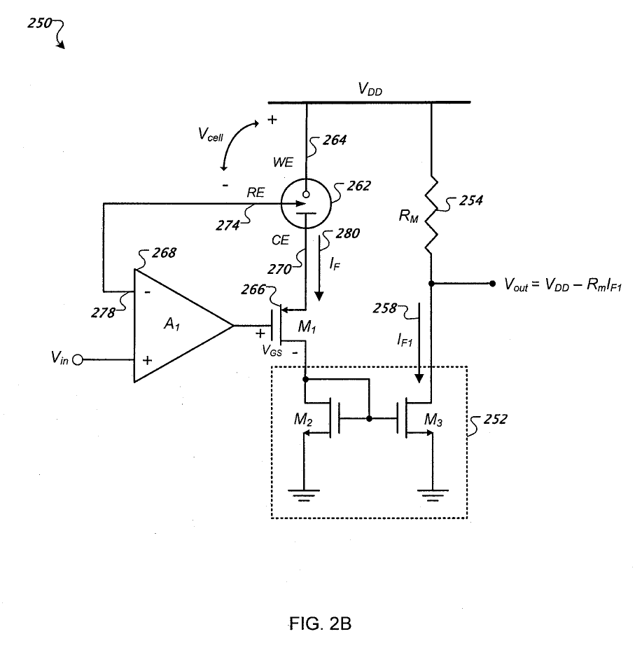

Referring now to FIG. 3, a potentiostat circuit 302 includes current replication using multiple current mirrors according to one embodiment. The potentiostat circuit 302 is similar to the potentiostat circuit 250 in FIG. 2B with a second current mirror 304. In the potentiostat circuit 302, a current mirror 306 mirrors the sensor current 310, I_{F}, flowing through an electrochemical cell 308, resulting in a first mirrored current 312, I_{F1}. The second current mirror 304 mirrors the first mirrored current 312, I_{F1}, resulting in a second mirrored current 314, I_{F2}.

A current measurement resistor 316 may be placed into the path of the second mirrored current 314, I_{F2}. An output voltage, Vₒᵤₜ, generated across the resistor 316 may be measured, where the output voltage, Vₒᵤₜ, is related to the second mirrored current 314, I_{F2}, according to: Vₒᵤₜ=R_{M}*I_{F2}. The output voltage, Vₒᵤₜ, may be measured with reference to ground. The output voltage, Vₒᵤₜ, is related to the sensor current 310, I_{F}, flowing through the electrochemical cell 308, as the second mirrored current 314, I_{F2}, is a mirrored version (or copy) of the current of the sensor current 310, I_{F}. The output voltage, Vₒᵤₜ, may be converted to a digital value by an ADC (not shown). The potentiostat circuit 302 allows measurement of a voltage, indicative of the sensor current 310, I_{F}, with reference to ground as opposed to a supply voltage.

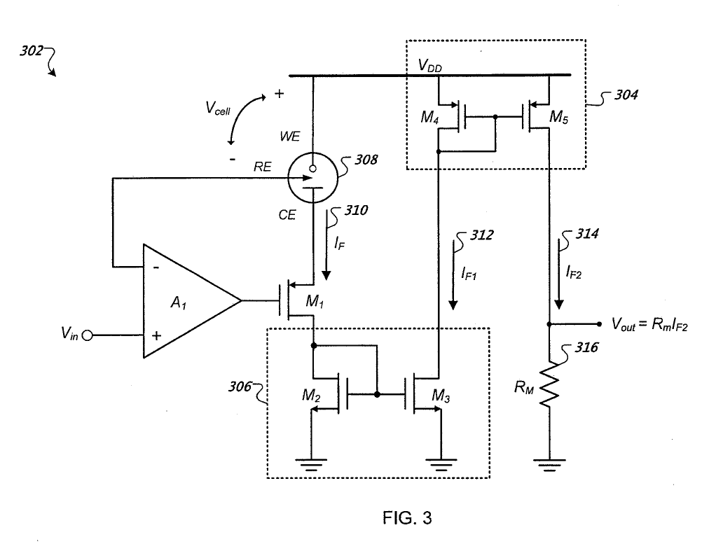

Turning now to FIG. 4, a potentiostat circuit 402 includes current replication using a cascode current mirror 404. The potentiostat circuit 402 also includes an electrochemical cell 406 and a amplifier 408. The potentiostat circuit 402 controls the voltage difference between a working electrode 410 and a reference electrode 412 of the electrochemical cell 406 by sourcing a current through a counter electrode 414. The potentiostat circuit 402 may also measure the sensor current 416, I_{F}, flowing through the electrochemical cell 406. According to one embodiment, the direction of the current through the electrochemical cell 406 is from the working electrode 410 to the counter electrode 414.

The working electrode 410 is coupled to a supply voltage, V_{DD}, to control the potential difference between the working electrode 410 and the reference electrode 412 in the electrochemical cell 406. For example, the working electrode 410 may be maintained at a positive voltage potential and the amplifier 408 may control the sensor current 416, I_{F}, such that a cell potential, V_{CELL}, measured with respect to the supply voltage, V_{DD}, and an inverting input 422 of the amplifier 408, is maintained at a desired level. In this embodiment, sensor current 416, I_{F}, flows through the working electrode 410 and the counter electrode 414.

The potentiostat circuit 402 controls the sensor current 416, I_{F}, flowing through the working electrode 410 and the counter electrode 414. In some embodiments, the sensor current 416, I_{F}, is controlled by a feedback loop, which sinks a current from the counter electrode 414 to maintain the potential difference between the working electrode 410 and the reference electrode 412 at a desired potential.

The amplifier 408 controls a voltage difference between the working electrode 410 and the reference electrode 412 in the electrochemical cell 406. In some embodiments, the voltage is controlled by adjusting the sensor current 416, I_{F}, flowing through the working electrode 410 and the counter electrode 414 while preventing any current from flowing through the reference electrode 412. Since current flow is substantially reduced through the reference electrode 412, the likelihood of change in the interfacial potential difference at the reference electrode 412 may be reduced resulting in better control of the interfacial potential difference at the working electrode 410.

In some embodiments, the sensor current 416, I_{F}, flowing through the electrochemical cell 406 is measured by placing the cascode current mirror 404 and a resistor 428 in the path of the sensor current 416, I_{F}. In some embodiments, the cascode current mirror 404 may be placed between the counter electrode 414 and ground in the path of the sensor current 416, I_{F}. The cascode current mirror 404 mirrors the sensor current 416, I_{F}, flowing between the working electrode 410 and the counter electrode 414 by generating a mirrored sensor current 426, I_{F1}. The amplifier 408 creates a feedback loop, through which the potential of the reference electrode 412 is stabilized at the desired cell potential, V_{CELL}.

The resistor 428 may be integrated into the path of the mirrored sensor current 426, I_{F1}. An output voltage, Vₒᵤₜ, generated across the resistor 428 may be measured, where the output voltage, Vₒᵤₜ, is related the mirrored sensor current 426, I_{F1}, according to: Vₒᵤₜ=R_{M}*I_{F1}. Therefore, the output voltage, Vₐᵤₜ, may be related to the sensor current 416, I_{F}, flowing through the electrochemical cell 406, as the mirrored sensor current 426, I_{F1}, is a mirrored version (or copy) of the sensor current 416, I_{F}. The output voltage, Vₐᵤₜ, may be converted to a digital value by an ADC (not shown). The use of the cascode current mirror 404 in the potentiostat circuit 402 minimizes the current mismatch between the transistors 434, 436, 438, 440 included in the current mirror improving the accuracy of the mirrored sensor current 426, I_{F}.

The value of the bias voltage, V_{B}, may be high enough to keep transistors 434, 436, 438, 440 in a saturation region (e.g., the value of the bias voltage is greater that V_{GS}+V_{DSsat} for transistor 434). In some embodiments, the bias voltage is a fixed voltage. In other embodiments, the bias voltage, V_{B}, is changed adaptively with the current flowing through the transistors 434, 436, 438, 440.

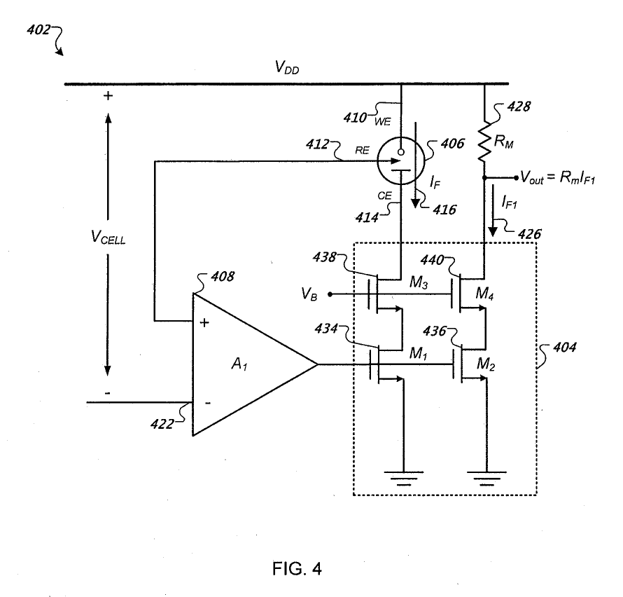

Turning now to FIG. 5, a potentiostat circuit 502 with current replication may be fabricated using bipolar transistor technology according to one embodiment. The potentiostat circuit 502 is similar to the potentiostat circuit 150 in FIG. 1B with a current mirror 508. The potentiostat circuit 502 includes an electrochemical cell 504, a control amplifier 506, and the current mirror 508. The potentiostat circuit 502 controls the voltage difference between a working electrode 510 and a reference electrode 512 of the electrochemical cell 504 by sinking a current into the electrochemical cell 504 through a counter electrode 514. The potentiostat circuit 502 measures the sensor current 516, I_{F}, flowing through the electrochemical cell 504. In one embodiment, the direction of the current through the electrochemical cell 504 is from the working electrode 510 to the counter electrode 514.

In some embodiments, bipolar fabrication technology is used for implementing the potentiostat circuit 502. In other implementations, the potentiostat circuit 502 is implemented using a combination of CMOS and bipolar fabrication technology. For example, the control amplifier 506 may be fabricated using CMOS, and the current mirror 508 may be fabricated using bipolar transistors.

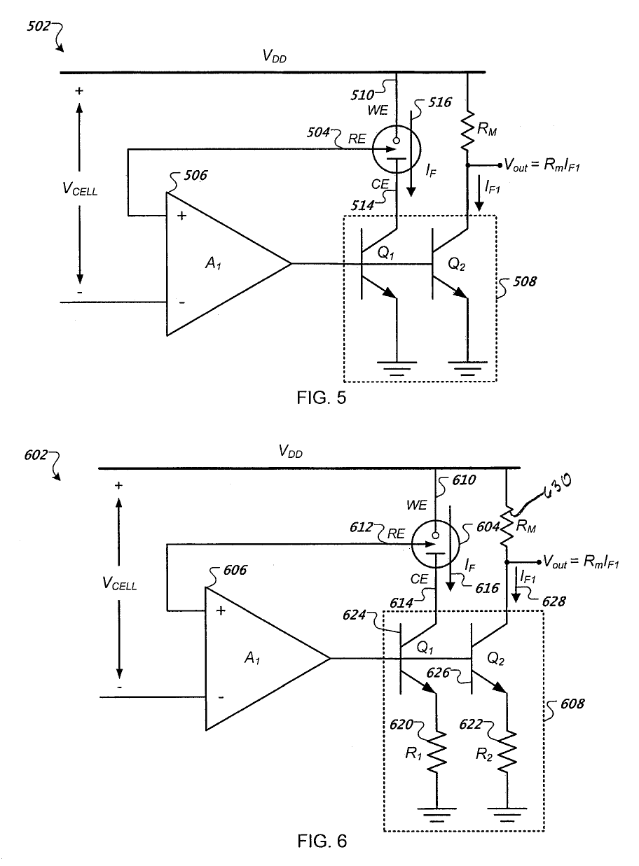

Referring now to FIG. 6, a potentiostat circuit 602 with current replication includes increased gain. The potentiostat circuit 602 performs in a similar manner as the potentiostat circuit 502 in the FIG. 5. The potentiostat circuit 602 includes an electrochemical cell 604, a control amplifier 606, and a current mirror 608. The current mirror 608 includes transistors 624, 626 and resistors 620, 622. The potentiostat circuit 602 controls the voltage difference between a working electrode 610 and a reference electrode 612 by sinking a current into the electrochemical cell 604 through a counter electrode 614. The potentiostat circuit 602 also measures the sensor current 616, I_{F}, flowing through the electrochemical cell 604 with a resistor 630. According to one embodiment, the direction of the current through the electrochemical cell 604 is from the working electrode 610 to the counter electrode 614.

The values for the resistor 620 and the resistor 622 as well as the matching of the transistor 624 and the transistor 626 determine the current gain applied to a mirrored sensor current 628, I_{F1}. The amount of current gain applied determines the output voltage, Vₒᵤₜ. For example, if R₂=4*R₁ and Q₂=4*Q₁, a gain of four may be applied to the mirrored sensor current 628, I_{F1}. In this example, the resistor 620 may be chosen to be 10 kOhms, and the resistor 622 may be chosen to be 40 kOhms. In some embodiments, the selection of gain (if any) to apply to the mirrored sensor current 628, I_{F}, depends on the type of sensor used, the fabrication technology, the limits on power consumption and noise generation, and the measurement precision desired.

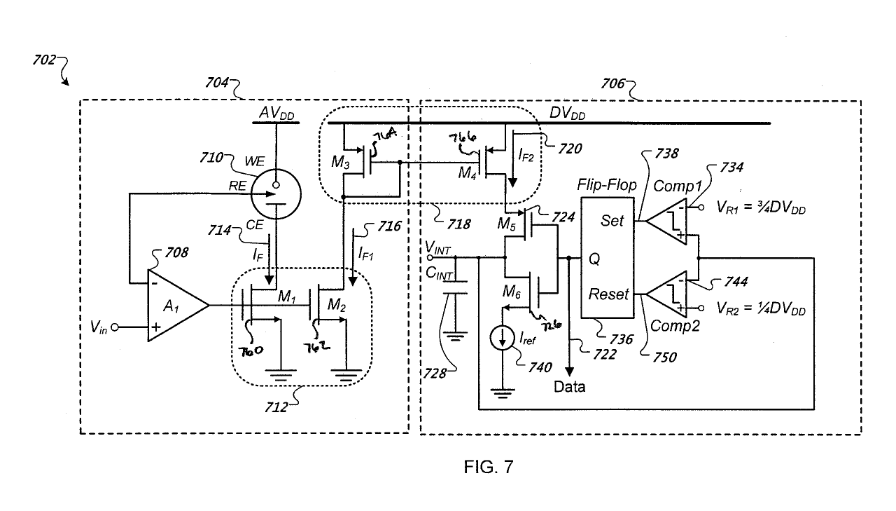

Turning now to FIG. 7, a potentiostat circuit 702 includes a current replication potentiostat circuit 704 and a current-to-frequency converter 706. The potentiostat circuit 704 includes a control amplifier 708, an electrochemical cell 710, and a first current mirror 712. The potentiostat circuit 704 may be used, for example, in an oxidation electrochemical process. The potentiostat circuit 704 is similar to the potentiostat circuit 150 in FIG. 1B. The current-to-frequency converter 706 converts the mirrored sensor current 716, I_{F1}, to a time based value for measurement.

The first current mirror 712 mirrors the sensor current 714, I_{F}, resulting in a first mirrored sensor current 716, I_{F1}. A second current mirror 718 mirrors the first mirrored sensor current 716, I_{F1}, resulting in a second mirrored sensor current 720, I_{F2}. The second mirrored sensor current 720, I_{F2}, is input to the current-to-frequency converter 706. In some embodiments, the first mirrored current, I_{F1}, is input the current-to-frequency converter 706. In other embodiments, the use of a second current mirror 718 to mirror the first mirrored sensor 716, I_{F}, input current to the current-to-frequency converter 706 minimizes the kickback effect of the current-to-frequency converter 706 to the potentiostat circuit 704. Transistors 760, 762, 764, 766 included in the first current mirror 712 and the second current mirror 718 may be fabricated using a cascode topology improving the precision of the current mirrors 712, 718.

The operation of the current-to-frequency converter 706 may be described by first assuming that output 722, Data, of a flip-flop 736 is off. This implies that a transistor 724 is in an “ON” state and a transistor 726 is in an “OFF” state. The second mirrored sensor current 720, I_{F2}, may be integrated by a capacitor 728, C_{INT}, until a voltage, V_{INT}, across the capacitor 728 exceeds an input voltage, V_{R1}, to a comparator 734, where V_{R1}=¾DV_{DD}. The output of the comparator 734 is coupled to an input 738, Set, of the flip-flop 736. The flip-flop 736 may be set by the comparator 734 when the voltage across the capacitor 728 exceeds the input voltage to the comparator 734. A reference current 740, I_{ref}, may discharge the capacitor 728 until the voltage across the capacitor 728 exceeds an input voltage, V_{R2}, to the comparator 744, where V_{R2}=¼DV_{DD}. The output of the comparator 742 is coupled to an input 750, Reset, of the flip-flop 736. The flip-flop 736 may be reset by the comparator 744 when the voltage across the capacitor 728 exceeds the input voltage, V_{R2}, to the comparator 744. The cycle of charging and discharging capacitor 728 results in the voltage across the capacitor 728 having a saw-tooth waveform. The output 722, Data, of the flip-flop 736 may be a low-duty cycle pulse waveform, for which the time difference between two consecutive pulses, T, and pulse width, D, can be represented by:

$$T = \frac{{V}_{DD} {C}_{INT}}{2 {I}_{F}} and D = \frac{{V}_{DD} {C}_{INT}}{2 {I}_{ref}} .$$

T is inversely proportional to I_{F}, and D is a constant. Thus, the time difference between two consecutive pulses, T, is dependent on the sensor current, I_{F}. In other embodiments, the current-to-frequency converter 706 may convert the second mirrored sensor current 720, I_{F2}, to different waveforms such as, for example, a sine, cosine, square, or a pulse train.

In some embodiments, independent bias voltages are used for the potentiostat circuit 704 and the current-to-frequency converter 706. The use of independent bias voltages minimizes the injection of switching noise from the current-to-frequency converter 706 into the potentiostat circuit 704. In some embodiments, the supply voltage and ground are isolated between the potentiostat circuit 704 and the current-to-frequency converter 706. For example, the potentiostat circuit 702 includes a supply voltage, AV_{DD}, and a supply voltage, DV_{DD}, which are isolated from one another and may be supplied from two separate power sources.

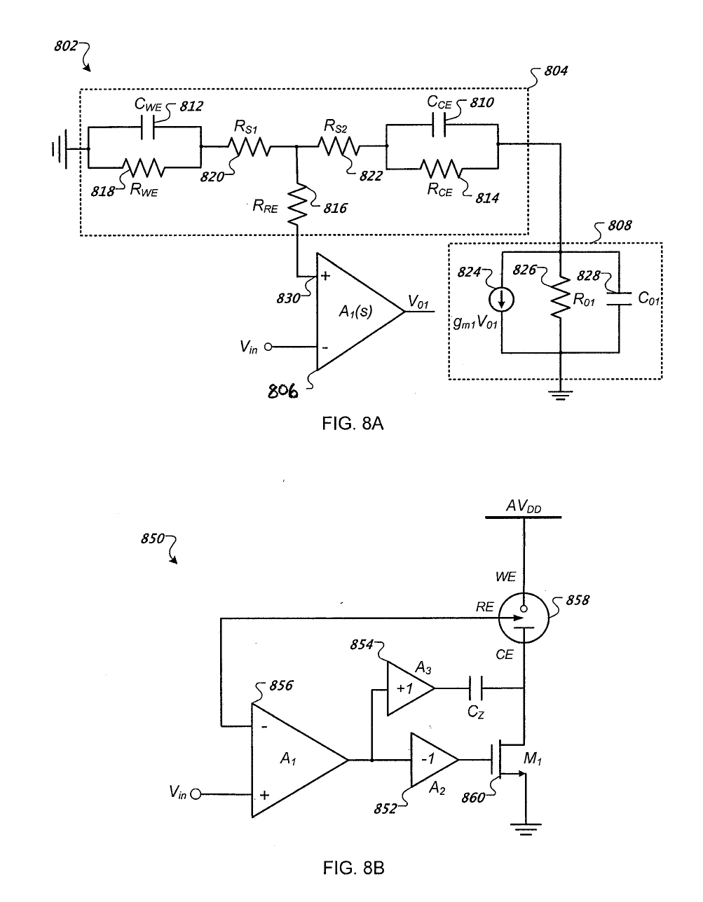

Turning to FIG. 8A is a small-signal model 802 of a potential control loop for a potentiostat circuit is illustrated according to one embodiment. The small-signal model 802 includes an electrochemical sensor small-signal model 804, a control amplifier small-signal model 806, and a transistor small-signal model 808. The small-signal model 802 may be used to model the potential control loops included in the exemplary embodiments of FIGS. 1A, 1B, 2A, 2B, 3, 4, 5, 6, and 7. In general, a potential control loop includes a control amplifier, an electrochemical cell, and a transistor. For example, the control amplifier 154, the electrochemical cell 152 and the transistor 176 of the potentiostat circuit 150 in FIG. 1B are an example of a potential control loop for the potentiostat circuit 150.

In some embodiments, the frequency compensation of a potential control loop is an important aspect of a potentiostat circuit. An electrochemical cell, which may have the likelihood for highly nonlinear impedance, provides a load and feedback network for a control amplifier. Additionally, the impedance of an electrochemical cell may be dependent on a plurality of variables that include, but are not limited to, voltage, temperature, concentration of electroactive species on an electrode of the electrochemical cell, and the roughness of the electrode surfaces of the electrochemical cell. Therefore, stable potentiostat circuits are desirable in order to handle large load variations during the operation of the electrochemical sensor.

The electrochemical sensor small-signal model 804 includes a capacitor 810, C_{CE}, and a capacitor 812, C_{WE}. The capacitors 810, 812 represent the double layer capacitances of a counter electrode and a working electrode, respectively. The electrochemical sensor small-signal model 804 also includes a resistor 814, R_{CE}, resistor 816, R_{RE}, and resistor 818, R_{WE}. The resistors 814, 816, 818 represent the charge transfer resistances of a counter electrode, a reference electrode, and a working electrode, respectively. The electrochemical sensor small-signal model 804 also includes a resistor 820, R_{S1}, and a resistor 822, R_{S2}, representing a solution resistance.

The small-signal model 802 includes the transistor small-signal model 808. For example, referring to FIG. 1B, the transistor small-signal model 808 may represent the transistor 176 in the potential control loop of the potentiostat circuit 150. Referring to the transistor small-signal model 808, gₘ₁ represents a transconductance 824 of the transistor, a resistor 826, R₀₁, represents the output resistance of the transistor, and a capacitor 828, C₀₁, represents the tamplifier1 drain capacitance of the transistor.

In some embodiments, the use of a single-stage amplifier for a control amplifier improves the stability of a potential control loop. The single-stage amplifier introduces one low frequency dominant pool into the potential control loop. The single-stage amplifier 806 of the small-signal model 802 of the potential control loop may be modeled using the transfer function:

$${A}_{1} ( s ) = \frac{{A}_{OL 1}}{1 + \frac{s}{{p}_{A 1}}}$$

where A_{OLI} is the open-loop gain of the amplifier 806 and p_{A1} is the dominant pole of the amplifier 806.

In some embodiments, if the feedback loop of the potential control loop is disconnected at the non-inverting input 830 of the amplifier 806, the calculated open-loop transfer function may be:

$$H ( s ) = \frac{- Aol 1 ( 1 + {sC}_{CE} {R}_{CE} ) ( {R}_{WE} + {R}_{S 1} + {sC}_{WE} {R}_{S 1} + {R}_{WE} ) {g}_{m 1} {R}_{01}}{Δ ( s ) ( 1 + \frac{s}{{p}_{A 1}} )} , \\ where$$

$$Δ ( s ) = s 3 ( {R}_{S 1} {R}_{WE} {C}_{WE} {R}_{CE} {C}_{CE} {R}_{O 1} {C}_{O 1} + {R}_{S 2} {R}_{WE} {C}_{WE} {R}_{CE} {C}_{CE} {R}_{O 1} {C}_{O 1} ) + s 2 ( {R}_{S 1} {R}_{O 1} {C}_{O 1} {R}_{CE} {C}_{CE} + {R}_{CE} {R}_{O 1} {C}_{O 1} {R}_{WE} {C}_{WE} + {C}_{O 1} {R}_{O 1} {R}_{S 2} {C}_{WE} {R}_{WE} + {C}_{O 1} {R}_{O 1} {C}_{WE} {R}_{S 1} {R}_{WE} + {C}_{CE} {R}_{CE} {R}_{O 1} {C}_{WE} {R}_{WE} + {C}_{O 1} {R}_{CE} {R}_{O 1} {C}_{CE} {R}_{WE} + {R}_{S 2} {R}_{CE} {C}_{CE} {R}_{O 1} {C}_{O 1} + {C}_{CE} {R}_{CE} {C}_{WE} {R}_{S 1} {R}_{WE} + {C}_{CE} {R}_{S 2} {R}_{CE} {C}_{WE} {R}_{WE} ) + s ( {R}_{S2} {R}_{CE} {C}_{CE} + {R}_{O 1} {R}_{CE} {C}_{CE} + {R}_{CE} {R}_{O 1} {C}_{O 1} + {R}_{S 1} {R}_{WE} {C}_{WE} + {R}_{WE} {R}_{O 1} {C}_{O 1} + {R}_{S 1} {R}_{O 1} {C}_{O 1} + {R}_{O 1} {R}_{WE} {C}_{WE} + {R}_{S 2} {R}_{O 1} {C}_{O 1} + {R}_{WE} {R}_{CE} {C}_{CE} + {R}_{S 1} {R}_{CE} {C}_{CE} + {R}_{CE} {R}_{WE} {C}_{WE} + {R}_{S 2} {R}_{WE} {C}_{WE} ) + {R}_{WE} + {R}_{CE} + {R}_{S 1} + {R}_{S 2} + {R}_{O 1} .$$

For example, the open-loop transfer function, H(s), may indicate that the potential control loop includes two left-half-plane (LHP) zeros located at:

$${z}_{1} = - \frac{1}{{C}_{WE} ( {R}_{WE} ‖ {r}_{{S}_{1}} )} and {z}_{2} = - \frac{1}{{C}_{WE} {R}_{CE}} .$$

The positions of the frequency poles in the open-loop transfer function, H(s), may be difficult to determine due to the level of complexity of the denominator of the open-loop transfer function. In order to determine the frequency poles of the open-loop transfer function, the denominator of the open-loop transfer function may be simplified based on a number of assumptions. The first assumption can be that the capacitor 828, C₀₁, whose capacitance is the tamplifier1 parasitic capacitance at the drain of the transistor (modeled by the transistor small-signal model 808), is smaller than capacitor 810, C_{CE}, and the capacitor 812, C_{WE}, included in the electrochemical sensor small-signal model 804. The second assumption may be that the resistor 826, R_{O1}, whose resistance is the output resistance of the transistor (modeled by the transistor small-signal model 808), provides a large resistance because the current through the transistor is small. As shown in the above examples of potentiostat circuits, the current through the transistor may be the sensor current, which is in the range of nanoamperes. The third assumption may be that the solution resistors: the resistors 820, 822 are smaller than the resistors in the electrochemical cell: the resistors 814, 816, 818. Using the above assumptions, the open-loop transfer function, H(s), may be simplified and frequency poles (p₁, p₂, p₃, and p₄) may be approximated by:

$${p}_{1} ≅ - \frac{1}{{C}_{WE} ( {R}_{WE} ‖ ( {R}_{CE} + {R}_{01} ) )} , \\ {p}_{2} ≅ {p}_{A 1} , {p}_{3} ≅ - \frac{1}{{C}_{CE} ( {R}_{CE} ‖ {R}_{01} )} , and$$

$${p}_{4} ≅ - \frac{1}{{C}_{01} ( {R}_{S 1} + {R}_{S 2} )} .$$

In some embodiments, the capacitor 812, C_{WE}, generates the dominant frequency pole, p₁. The amplifier 806 introduces the next frequency pole, p₂. Because the value of the resistor 814, R_{CE}, may be less than the value of the resistor 826, R_{O1}, the next frequency pole, p₃, may be close in value to the left-half-plane zero located at z₂. This may generate a frequency doublet, where the frequency of the left-half-plane zero located at z₂ is slightly less than the frequency of the frequency pole, p₃. The next frequency pole, p₄, may be located at a high frequency because the value of the capacitor 828. C_{O1}, is small and the sum of the solution resistors, the resistor 820, R_{S1}, and the resistor 822, R_{S2}, is also small. Frequency poles p₂, p₃, and p₄ may be referred to as non-dominant frequency poles where frequency pole, p₁, may be considered the dominant frequency pole.

In some embodiments, an integrated circuit chip can include a potentiostat circuit. The capacitor 812, C_{WE}, and the capacitor 810, C_{CE}, in the electrochemical sensor small-signal model 804 may be larger than the on-chip parasitic capacitances. Additionally, the dominant frequency pole, p₁, may be at a lower frequency compared to the other non-dominant frequency poles (p₂, p₃, and p₄).

Pushing non-dominant frequency poles to higher frequencies may improve stability in a potential control loop for a potentiostat circuit. In some embodiments, Miller compensation may be used and a capacitor placed between the drain and gate of the transistor. This results in pushing the frequency pole, p₂, to a lower frequency resulting in the value of the frequency pole, p₂, which is closer to the value of the dominant pole, p₁. Therefore, the use of Miller compensation may not be desirable. In some embodiments, minimizing the parasitic capacitances at the output node of the control amplifier, pushes the frequency pole, p₂, to a higher frequency. In some embodiments, minimizing the gain of the control amplifier, also pushes the frequency pole, p₂, to a higher frequency.

Referring now to FIG. 8B, a potential control loop 850 of a potentiostat circuit having a feedforward signal path is illustrated according to one embodiment. The potential control loop 850 includes an amplifier 856, an amplifier 852, an amplifier 854, an electrochemical cell 858, and a transistor 860. In some embodiments, a left-half-plane zero is added to a potential control loop using an additional feedforward signal path. The feedforward signal path reduces phase shift due to high frequency poles and right-half-plane zeros. In one embodiment, the amplifier 856 is a single stage amplifier, and the amplifier 852 and the amplifier 854 are unity gain, wide band, single stage amplifiers. The location of the additional left-half-plane zero may be at:

$${z}_{3} = - \frac{{g}_{m 1}}{{C}_{z}} .$$

Turning now to FIG. 8C an exemplary transistor level potentiostat circuit 880 is illustrated according to one embodiment. The potentiostat circuit 880 includes the potential control loop 850. A cascode current mirror 882 generates a mirrored sensor current 884, I_{F1}, from a sensor current 886, I_{F}. The current mirror 882 minimizes the current mismatch between the transistors 888, 890, 892, 894 included in the current mirror. The channel length of the transistors 888, 890, 892, 894 may be increased in the current mirror 882. In one embodiment, increasing channel length of the transistors 888, 890, 892, 894 improves the precision of the mirrored sensor current 884, I_{F1}.

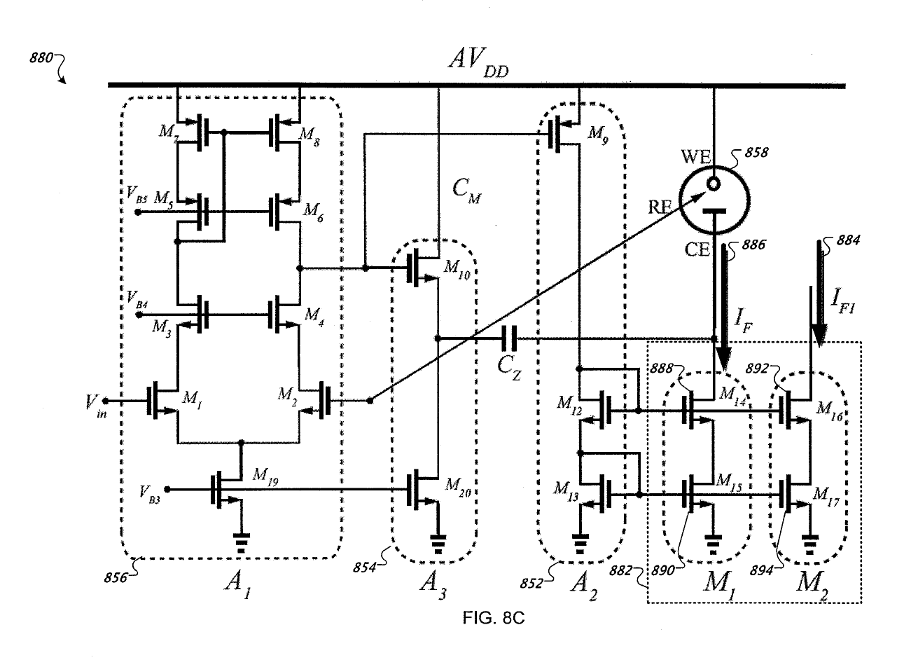

Referring now to FIG. 9, a method for controlling and replicating current through an electrochemical cell includes blocks 902, 904, 906, 908 according to one embodiment. The blocks of the method 900 may follow the order as shown, although in some cases, some or all of the steps may be executed in a different order.

At block 902, the potentiostat circuit applies a constant potential to the working electrode and the reference electrode. The constant potential may be provided, for example, by a potential control loop of a potentiostat circuit as previously described. At block 904, the potentiostat circuit produces a sensor current associated with an electrochemical reaction that flows through the working electrode and the counter electrode in the electrochemical cell. Next, at block 906, a current mirror replicates the sensor current, for example, by one or more of the embodiments described above.

At block 908, the mirrored current is converted to a voltage, for example, by a drop across a resistor. In some embodiments, the mirrored current is converted to a frequency modulated pulse waveform, where the time difference between two consecutive pulses is inversely proportional to the sensor current. The measurement of the time difference between two consecutive pulses, therefore, is indicative of the value of the sensor current.

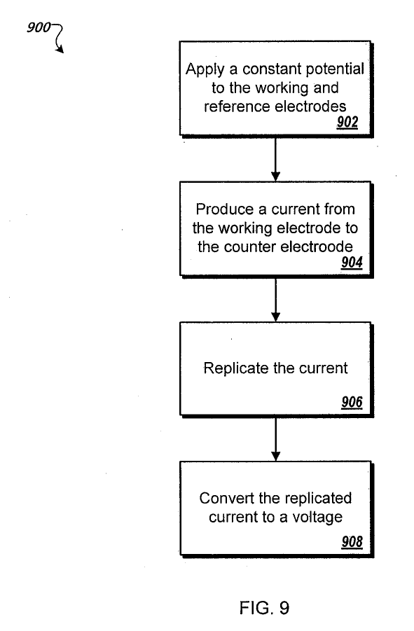

Referring now to FIG. 10, a method for determining the concentration of an analyte in a chemical species using a portable monitoring device according to one embodiment includes blocks 1002, 1004, 1006. The blocks of the method 1000 may follow the order shown in FIG. 10, although in some cases, some or all of the blocks may be accomplished in a different order.

At block 1002, the electrodes of an electrochemical cell, included in the portable monitoring device, are placed in a solution where a constituent of the solution is a chemical species of interest. In some embodiments, the solution is human blood and the chemical species of interest is glucose. An electrochemical reaction occurs that produces an analyte in the chemical species. The concentration of the analyte in the chemical species may be monitored by, for example, the method 900 described with respect to FIG. 9.

At block 1004, the output voltage as measured by the monitoring device is determined. In some embodiments, the voltage is measured using an analog-to-digital converter (ADC). In some embodiments, the ADC includes a display, which indicates (e.g., visually or audibly) the representative digital value to the user. The voltage value, and therefore the representative digital value, may be proportional to the concentration of the analyte in the chemical species. At block 1006, the concentration of the analyte in the chemical species is determined based on the measured voltage. For example, conversion may include a table that equates representative digital values to a specific analyte concentration.

In another example, an electronic device may include an ADC to convert the measured voltage in block 1004 and a look-up table that converts the measured voltage to a specific analyte concentration. The electronic device may include a display to display to a user the analyte concentration.

In yet another example, a portable monitoring device may include an amperometric electrochemical cell, an ADC, and associated software and/or hardware that receives a mirrored current measured by the electrochemical cell. In some, the associated software and/or hardware may receive a mirrored current value and perform a calculation that equates the mirrored current value to a medically-relevant diagnostic value. For example, in a portable glucose monitoring device, a blood sugar concentration may be displayed to the user based on a measured value of the patient's blood using the electrochemical sensor.

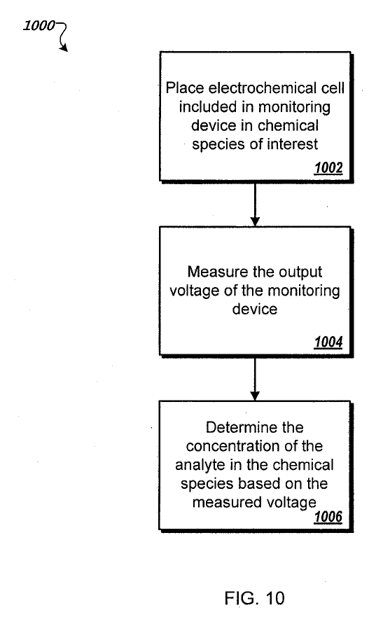

FIG. 11 illustrates a schematic diagram of a potentiostat 1100 according to one embodiment. The potentiostat 1100 includes a voltage controller 1110, a current copier 1120, and a current measurer 1130. The voltage controller 1110 controls the voltage difference cell potential, V_{CELL}, between a working electrode 1142 and a reference electrode 1146 of an electrochemical cell 1140, according to a desired input voltage, V_{IN}. The voltage controller 1110 may be one of, but not limited to, an operational amplifier (OA) or an operational transconductance amplifier (OTA). The potentiostat 1100 is coupled to three supply voltages including V_{SS}, V_{DD}, and ground, but it may also be coupled to more or less supply voltages.

The current copier 1120 is coupled to the working electrode 1142. It generates a copy current, I_{WE1}, of the sensor current, I_{WE}. The current copier 1120 may be one of, but not limited to, a standard current mirror, a cascode, regulated cascode (gain-boosted), Wilson or Widlar current mirror. The current copier 1120 may have one or more couplings to the voltage controller 1110. The voltage controller 1110 and the current copier 1120 may also share one or more electrical elements, such as transistors, capacitors, or resistors.

The copied current, I_{WE1}, may be measured with the current measurer 1130. The current measurer 1130 may include a resistor (not shown) coupled between the input of the current measurer 1130 and a fixed potential. The resistor converts the copy current, I_{WE1}, into a voltage. The current measurer 1130 may also be, but is not limited to, a current-input analog-to-digital converter, a current-input sigma-delta modulator, or even a current-to-frequency converter.

The current measurer 1130 may have one or more couplings to the current copier 1120. There may be some electric elements, such as a transistor, capacitor, or resistor, shared between the current measurer and the current copier. The current measurer 1130 may receive one or more copy currents from the current copier 1120. The copy current, I_{WE1}, may be equal, amplified or even attenuated versions of the sensor current, I_{WE}.

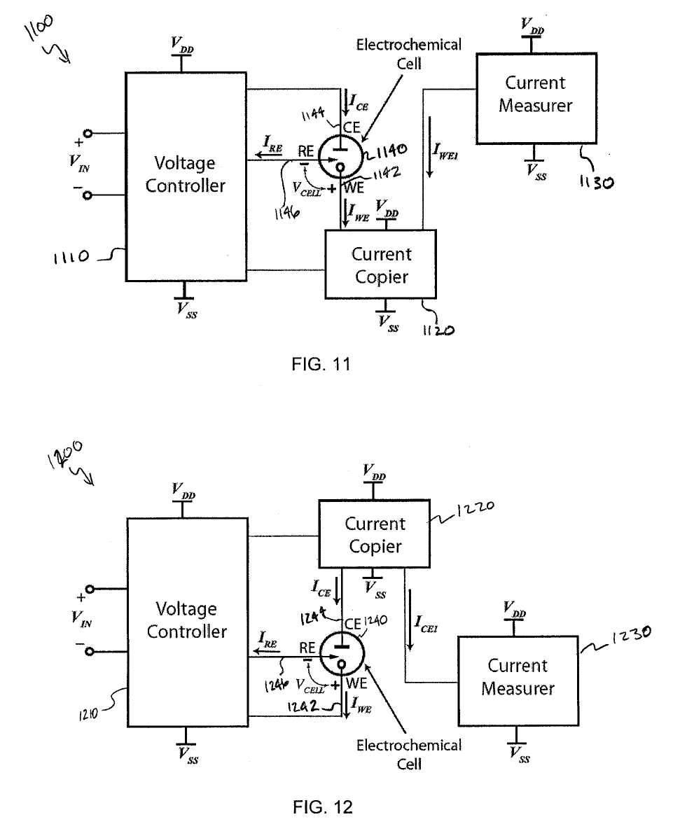

FIG. 12 is a schematic diagram of a potentiostat 1200 according to another embodiment. This embodiment functions similar to FIG. 1, with the exception that a current copier 1220 is coupled to the counter electrode 1244 instead of the working electrode 1242. In a three-electrode electrochemical cell, the current flowing through the reference electrode, I_{RE}, is smaller than the sensor current, I_{WE}, thus, the electric current flowing in the counter electrode, I_{CE}, is approximately the sensor current, I_{WE}. The current copier 1220 generates a copy current, I_{CE1}, of the counter electrode current, I_{CE}. Because the counter electrode current, I_{CE}, approximates I_{WE}, the mirrored counter electrode current, I_{CE1}, is a copy of the working electrode current, I_{WE}. The current copier 1220 may be, for example, a standard, cascode, regulated cascode (gain-boosted), Wilson, or Widlar current mirror.

The voltage controller 1210 controls the cell potential, V_{CELL}, according to a desired input voltage, V_{IN}. The voltage controller 1210 may be one of, but not limited to, an amplifier or an amplifier. The current measurer 1230 may have one or more electrical couplings to the current copier 1220. There may be some elements, such as transistors, capacitors, or resistors, shared between the current measurer and the current copier. The current measurer 1230 may receive one or more copy current, I_{CE1}, from the current copier 1220. The copy currents, I_{CE1}, may be approximate, amplified or attenuated versions of the counter electrode current, I_{CE}.

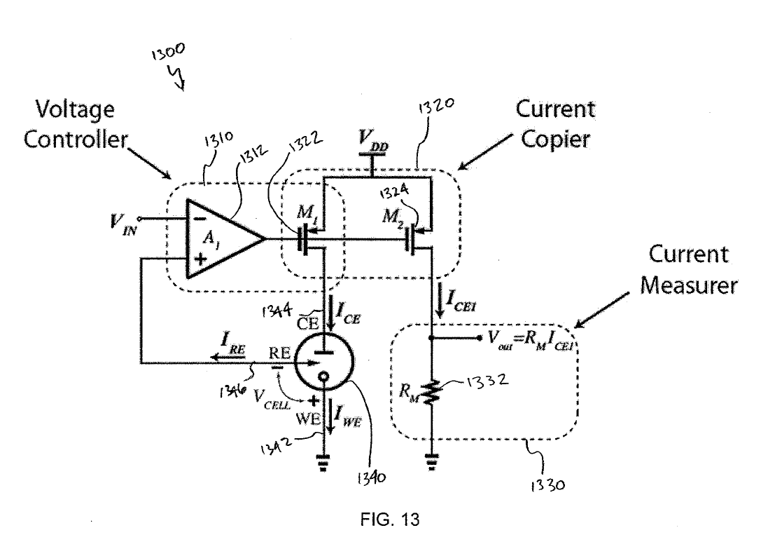

FIG. 13 is a circuit schematic illustrating an exemplary potentiostat used for electrochemical sensors for which the sensor current is a result of a reduction reaction at the surface of the working electrode according to one embodiment. A potentiostat 1300 receives a positive supply voltage, V_{DD}, and ground. The potentiostat 1300 includes a voltage controller 1310 having an amplifier 1312 and a transistor 1322. A working electrode 1342 of an electrochemical cell 1340 is coupled to ground, and an input voltage, V_{IN}, is applied to the inverting input of the amplifier 1312. The voltage controller 1310 adjusts the cell potential, V_{CELL}, according to the input voltage, V_{IN}. Little or no electric current flows through a reference electrode 1346 because the reference electrode 1346 is coupled to the non-inverting input of amplifier 1312. Thus, the sensor current, I_{WE}, flowing through the working electrode 1342 is approximately equal to the current flowing in the counter electrode, I_{CE}.

A current copier 1320 includes transistors 1322, 1324. The potentiostat 1300 may be realized in an integrated circuit (IC) allowing close matching transistors 1322, 1324. The current copier 1320 copies the counter electrode current, I_{CE}, to the copied counter electrode current, I_{CE1}. By adjusting the aspect ratio (W/L) of the transistors 1322, 1324, the copied counter electrode current I_{CE1} may be either approximated, amplified, or attenuated version of the counter electrode current, I_{CE}. Increasing the channel length of the transistors 1322, 1324 further minimizes the current mismatch between the copied counter electrode current, I_{CE1}, and the counter electrode current, I_{CE}.

A current measurer 1330 includes a current measurement resistor 1332 coupled between the output of the current copier 1320 and ground. An output voltage, Vₒᵤₜ, across the resistor 1332 is related to the copied counter electrode current, I_{CE1}, according to the equation: Vₒᵤₜ=R_{M}*I_{CE1}. The output voltage, Vₒᵤₜ, is related to the sensor current, I_{WE}, flowing through the electrochemical cell because the copied counter electrode current, I_{CE1}, is a mirrored (or copy) version of the counter electrode current, I_{CE}, and the counter electrode current, I_{CE}, is approximately the sensor current, I_{WE}. In one embodiment, the output voltage, Vₒᵤₜ, is measured using an ADC (not shown).

The possibility of noise and interference pick-up at the working electrode 1342 is reduced because the working electrode 1342 is coupled to a true ground potential. Additionally, the circuit provides better signal integrity, because it uses fewer active and passive components for measuring current. Further, the power consumption of the circuit is reduced because the amplifier 1312 is the only major power consumer. Additionally, small currents may be measured by increasing resistance of the current measurement resistor 1332 without impacting the frequency stability of the voltage controller.

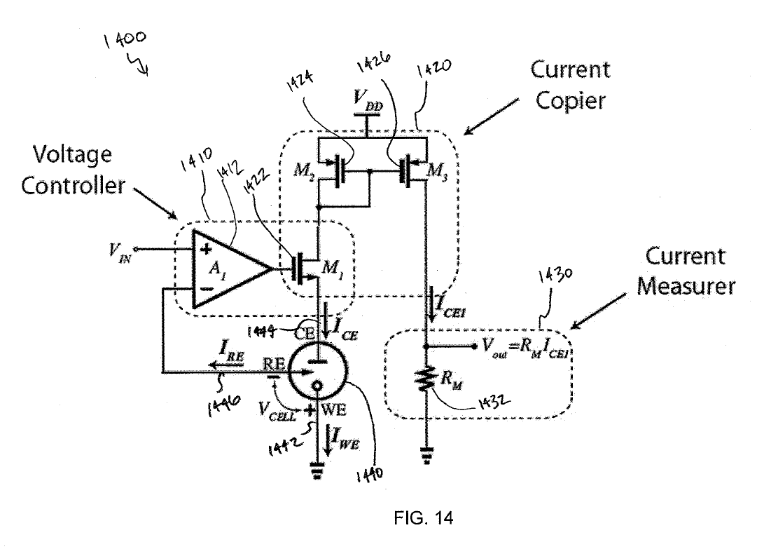

FIG. 14 illustrates an exemplary potentiostat used for electrochemical sensors for which the sensor current is a result of a reduction reaction at the surface of the working electrode according to one embodiment. A potentiostat 1400 includes a voltage controller 1410 having an amplifier 1412 and a transistor 1422 in a common-drain stage configuration improving stability. The voltage controller 1410 controls the cell potential, V_{CELL}, according to an input voltage, V_{IN}, applied to the non-inverting input of amplifier 1412. Little to no electric current flows in a reference electrode 1446 because the reference electrode 1446 is coupled to the inverting input of amplifier 1412. Thus, the sensor current, I_{WE}, flowing in the working electrode 1442 is approximately the counter electrode current, I_{CE}.

A current copier 1420 includes transistors 1422, 1424, 1426. The transistor 1422 conveys the counter electrode current, I_{CE}, to the current mirror having the transistors 1424, 1426. The transistors 1424, 1426 may be closely matched. The current of the counter electrode current, I_{CE}, is copied to a copied counter electrode current, I_{CE1}. By adjusting the aspect ratio (W/L) of the transistors 1424, 1426 the copied counter electrode current, I_{CE1}, may be either an approximate, amplified, or attenuated version of the counter electrode current, I_{CE}. Increasing channel length of the transistors 1424, 1426 minimizes the current mismatch between the copied counter electrode current, I_{CE1}, and the counter electrode current, I_{CE}. In order to increase the headroom for the signal swing at the counter electrode a zero or low threshold-voltage transistor may be used for the transistor 1422.

A current measurer 1430 includes a current measurement resistor 1432 coupled between the current copier 1420 and ground. An output voltage, Vₒᵤₜ, across the resistor 1432 is related to the copied counter electrode current, I_{CE1}, according to the equation: Vₒᵤₜ=R_{M}*I_{CE1}. The output voltage, Vₒᵤₜ, is related to the sensor current, I_{WE}, flowing through the electrochemical cell 1440 because the copied counter electrode current I_{CE1} is a mirrored (or copied) version of the counter electrode current, I_{CE}, and the counter electrode current, I_{CE}, is approximately the sensor current, I_{WE}. In one embodiment, the output voltage, Vₒᵤₜ, may be measured using an ADC (not shown).

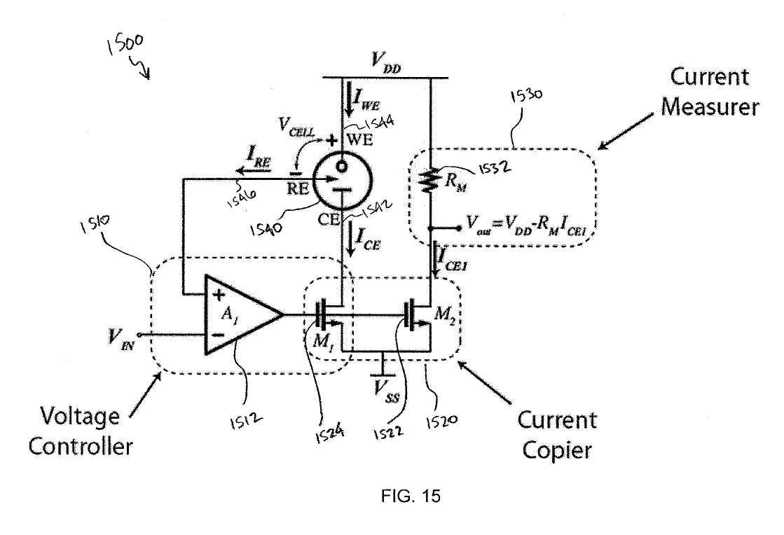

FIG. 15 is a circuit diagram illustrating an exemplary potentiostat used for electrochemical sensors for which the sensor current is the result of an oxidation reaction at the surface of the working electrode according to one embodiment. The potentiostat 1500 includes a voltage controller 1510 includes an amplifier 1512 and an NMOS transistor 1524. The voltage controller 1510 controls the cell potential, V_{CELL}, according to an input voltage, V_{IN}, applied to the inverting input of the amplifier 1512.

The potentiostat 1500 also includes a current copier 1520 having transistors 1522, 1524. This potentiostat 1500 may be realized in ICs, allowing the transistors 1522, 1524 to be closely matched. Since both transistors have the same gate to source voltage, V_{GS}, the counter electrode current, I_{CE}, is copied to the copied counter electrode current, I_{CE1}. By adjusting the aspect ratio (W/L) of the transistors 1522, 1524, the copied counter electrode current, I_{CE1}, may be either an approximated, amplified, or attenuated version of the counter electrode current, I_{CE}. Increasing the channel length of the transistors 1522, 1524 minimizes the current mismatch between the copied counter electrode current, I_{CE1}, and the counter electrode current, I_{CE}.

A current measurer 1530 includes a current measurement resistor 1532 coupled between the output of the current copier 1520 and the supply voltage, V_{DD}. An output voltage, Vₒᵤₜ, of the current measurer 1530 is related to the copied counter electrode current, I_{CE1}, according to the equation: Vₒᵤₜ=V_{DD}−R_{M}*I_{CE1}. The output voltage, Vₒᵤₜ, is thus related to the sensor current, I_{WE}, flowing through the electrochemical cell because the copied counter electrode current, I_{CE1}, is a mirrored (or copied) version of the counter electrode current, I_{CE}, and the counter electrode current, I_{CE}, is approximately the sensor current, I_{WE}. In one embodiment, the output voltage, Vₒᵤₜ, is measured using an ADC (not shown).

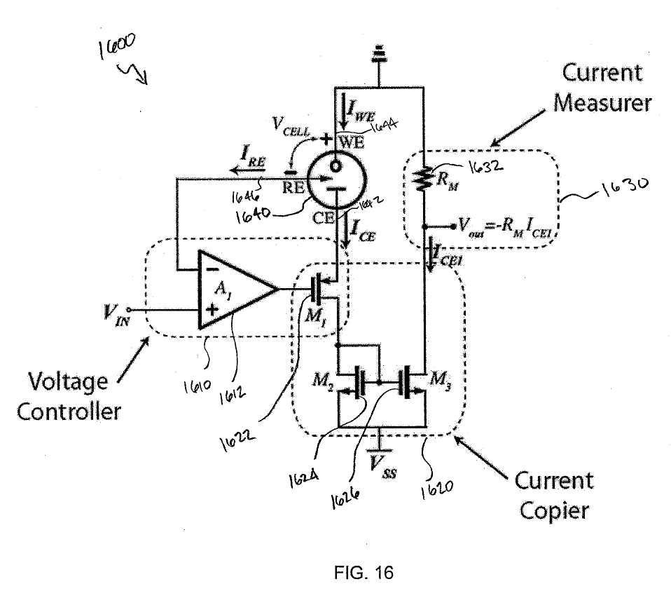

FIG. 16 is a circuit diagram illustrating an exemplary potentiostat used for electrochemical sensors for which the sensor current is the result of an oxidation reaction at the surface of the working electrode according to one embodiment. A potentiostat 1600 includes a voltage controller 1610 having an amplifier 1612 and a transistor 1622. In this circuit, the transistor 1622 is used as a common-drain stage. The voltage controller 1610 controls the cell potential, V_{CELL}, according to an input voltage, V_{IN}, applied to the non-inverting input of the amplifier 1612. Little to no electric current flows through a reference electrode 1646 because the reference electrode 1646 is coupled to the inverting input of the amplifier 1612. Thus, the sensor current, I_{WE}, flowing in a working electrode 1644 is approximately the counter electrode current, I_{CE}, flowing through the counter electrode 1642.

The potentiostat 1600 also includes a current copier 1620 having transistors 1622, 1624, 1626. The transistor 1622 conveys the counter electrode current, I_{CE}, to the current mirror circuit of the transistors 1624, 1626. Since this potentiostat 1600 may be realized in ICs, the transistors 1624, 1626 may be closely matched. Since both transistors have the same gate to source voltage, V_{GS}, the counter electrode current, I_{CE}, is copied to the copied counter electrode current, I_{CE1}. By adjusting the aspect ratio (W/L) of the transistors 1624, 1626, the copied counter electrode current, I_{CE1}, may be an approximated, amplified, or attenuated version of the counter electrode current, I_{CE}. Increasing the channel length of the transistors 1624, 1626 minimizes the current mismatch between the copied counter electrode current, I_{CE1}, and the counter electrode current, I_{CE}. In order to increase the headroom for the signal swing at the counter electrode 1642 a zero or low threshold-voltage transistor may be used to realize the transistor 1622.

The potentiostat 1600 further includes a current measurer 1630 having a current measurement resistor 1632 coupled between the current copier 1620 and ground. An output voltage, Vₒᵤₜ, across the resistor 1632 is related to the copied counter electrode current I_{CE1}, according to the equation: Vₒᵤₜ=−R_{M}*I_{CE1}. The output voltage, Vₒᵤₜ, is related to the sensor current, I_{WE}, flowing through the electrochemical cell because the copied counter electrode current, I_{CE1}, is a mirrored (or copied) version of the counter electrode current, I_{CE}, and the counter electrode current, I_{CE}, is approximately the sensor current, I_{WE}. In one embodiment, the output voltage, Vₒᵤₜ, is measured with an ADC (not shown).

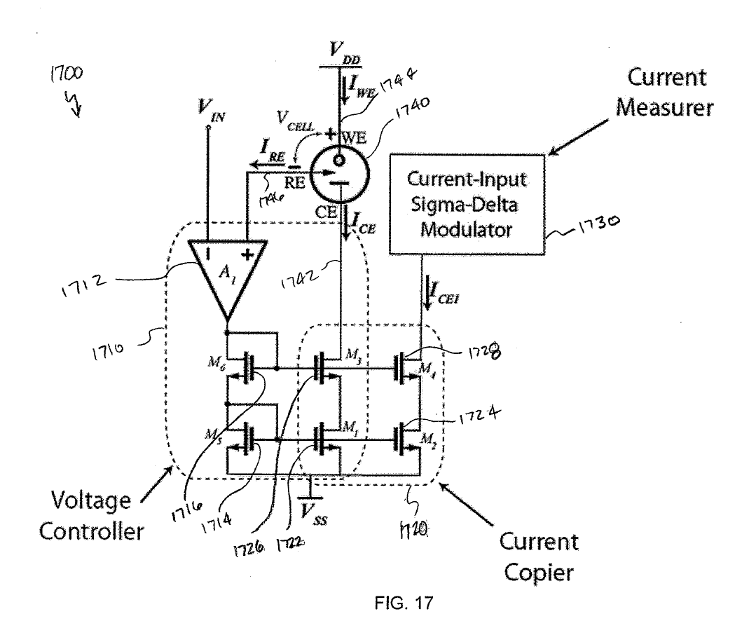

Turning now to FIG. 17 an exemplary potentiostat having cascode transistors used for electrochemical sensors for which the sensor current is the result of an oxidation reaction at the surface of a working electrode is illustrated according to one embodiment. A potentiostat 1700 may be used for electrochemical sensors for which the sensor current, I_{WE}, is the result of an oxidation reaction at the surface of a working electrode 1744. A voltage controller 1710 includes an amplifier 1712 and NMOS transistors 1722, 1726, 1714, 1716. The voltage controller 1710 controls the cell potential, V_{CELL}, according to an input voltage, V_{IN}, applied to the inverting input of the amplifier 1712.

The potentiostat 1700 also includes a current copier 1720 having NMOS transistors 1722, 1724, 1726, 1728. The transistors 1722, 1724 copy current, and the transistors 1726, 1728 reduce the mismatch between the drain to source voltage, V_{DS}, of the transistors 1722, 1724. Since this potentiostat 1700 may be realized in ICs, it is possible to closely match the transistors 1722, 1724. By adjusting the aspect ratio (W/L) of the transistors 1722, 1724, it is possible to make the copied counter electrode current, I_{CE1}, either an approximated, amplified, or attenuated version of the counter electrode current, I_{CE}. Increasing the channel length of the transistors 1722, 1724 minimizes the current mismatch between the copied counter electrode current, I_{CE1}, and the counter electrode current, I_{CE}.

Usually the ratio of the aspect ratio (W/L) of the transistor 1726 over the aspect ratio (W/L) of the transistor 1728 is equal to the ratio of the aspect ratio (W/L) of the transistor 1722 over the aspect ratio (W/L) of the transistor 1724 according to:

$$\frac{{( W / L )}_{2}}{{( W / L )}_{1}} = \frac{{( W / L )}_{4}}{{( W / L )}_{3}} .$$

Additional embodiments of the cascode current copier 1720 may include removing the transistors 1714, 1716 and coupling the amplifier 1712 to gates of the transistors 1722, 1724. Gates of the transistors 1726, 1728 may then be coupled to a fixed potential. Other more advanced current copiers, such as regulated cascode (gain-boosted) current mirrors may also be used to reduce the mismatch in the currents of the transistors 1722, 1724 due to the different drain-to-source voltage, V_{DS}, of the transistors 1722, 1724.

The potentiostat 1700 may also include a current measurer 1730 such as, for example, a current-input sigma-delta modulator, or other current measurers as described above. The current measurer 1730 may convert current to another signal for measurement such as a voltage, an audible signal, a time-modulated signal, a frequency-modulated signal, or an analyte concentration.

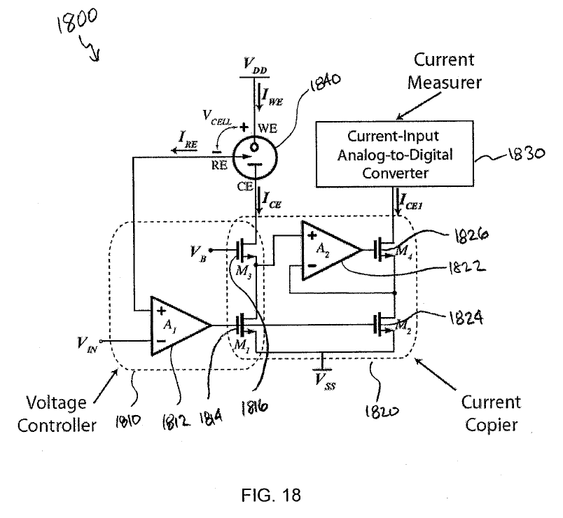

Turning now to FIG. 18 an exemplary potentiostat having a regulated cascode current copier to reduce current mismatch is illustrated according to one embodiment. A potentiostat 1800 includes a current copier 1820 includes having transistors 1814, 1824, 1816, 1826, and amplifier 1822. The feedback loop generated by the amplifier 1812 and the transistor 1826 maintains the drain-to-source voltage, V_{DS}, of the transistor 1824 approximately equal to the drain-to-source voltage, V_{DS}, of the transistor 1814. Since the gate-to-source voltage, V_{GS}, of the transistors 1814, 1824 are approximately equal, if the transistors 1814, 1824 are matched during fabrication process, their drain currents will be approximately matched. A potentiostat circuit as described may be realized in different circuit integration technologies, including, but not limited to, CMOS technology, bipolar technology and BiCMOS technology.

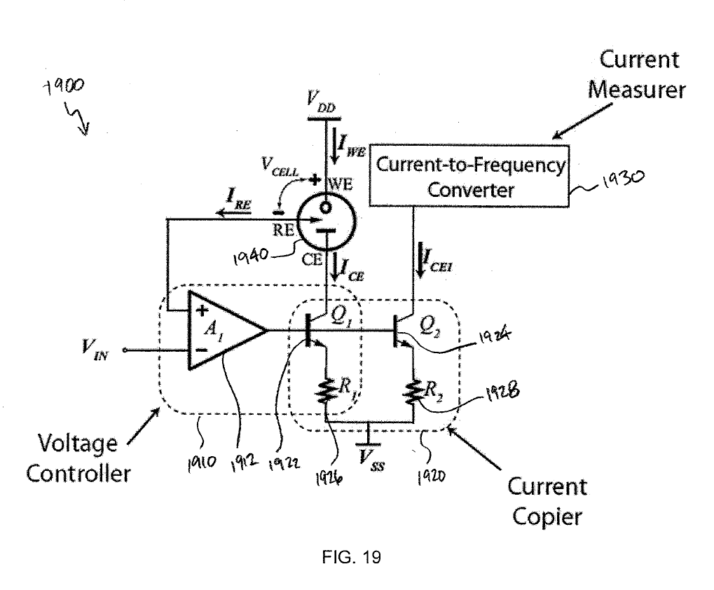

Referring now to FIG. 19 an exemplary potentiostat circuit used for electrochemical sensors for which the sensor current is the result of an oxidation reaction at the surface of the working electrode is illustrated according to one embodiment. A potentiostat 1900 includes a voltage controller 1910 having an amplifier 1912, a bipolar transistor 1922 and a resistor 1926. The voltage controller 1910 controls the cell potential, V_{CELL}, according to an input voltage, V_{IN}, applied to the inverting input of the amplifier 1912. The transistors 1922, 1924 may be realized using bipolar technology. Similarly the transistors of the voltage controller 1910 and a current measurer 1930 may be realized with bipolar or BiCMOS transistors.

The potentiostat 1900 performs in a similar manner as the potentiostat circuit shown in FIG. 15, but in this embodiment, the current copier 1920 is generated using the transistors 1922, 1924 and the resistors 1926, 1928. The resistors 1926, 1928 may be selected to reduce the mismatch between the counter electrode current, I_{CE}, and the copied counter electrode current, I_{CE1}. The copied counter electrode current, I_{CE1}, may be an approximated, amplified, or attenuated version of the counter electrode current, I_{CE}, by selecting different ratios for R2/R1 and Q2/Q1. For example, in order to have I_{CE1}=4*I_{CE}, R2/R1=4 and Q4/Q1=4 may be chosen. Still referring to the same example, R₁ may be chosen equal to 10 kOhms, R₂ may be chosen to be equal to 40 kOhms, and Q4/Q1=4 such that the transistor Q4 is made of the parallel connection of four NPN transistors each one precisely matched with the transistor 1922. The transistors 1922, 1924 further reduce mismatch of currents in the current copier 1920. A current measurer 1930 may be, for example, a current-to-frequency converter.

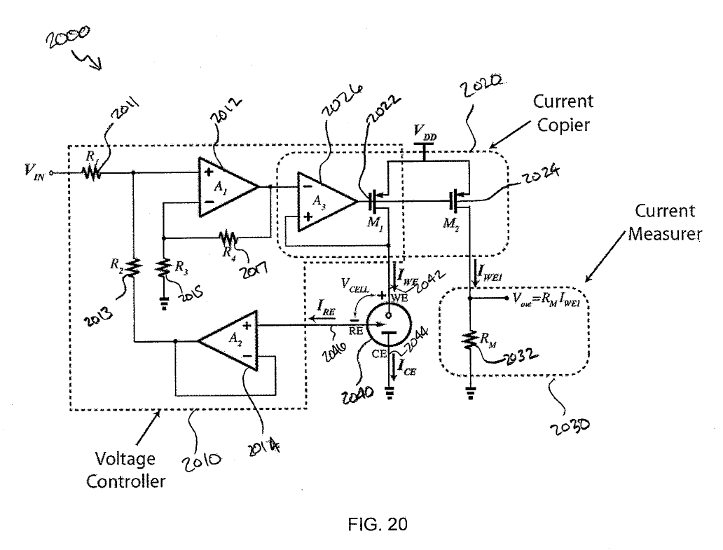

Turning now to FIG. 20 an exemplary potentiostat used for electrochemical sensors for which the sensor current is the result of an oxidation reaction at the surface of the working electrode is illustrated according to one embodiment. A potentiostat 2000 includes a voltage controller 2010 having amplifiers 2012, 2014, amplifier 2026, resistors 2011, 2013, 2015, 2017, and PMOS transistor 2022. The values and ratios among the resistors 2011, 2013, 2015, 2017 may be selected according to a desired design. For example, R1=R2=R3=R4=100 kohm.

The potentiostat 2000 also includes a current copier 2020 having amplifier 2026 and PMOS transistors 2022, 2024. The current copier 2020 is coupled to the working electrode 2042 and generates the copied counter electrode current, I_{WE1}, by directly coping the sensor current, I_{WE}. The potentiostat 2000 also includes a current measurer 2030 having a resistor 2032 coupled between the current copier 2020 and ground.

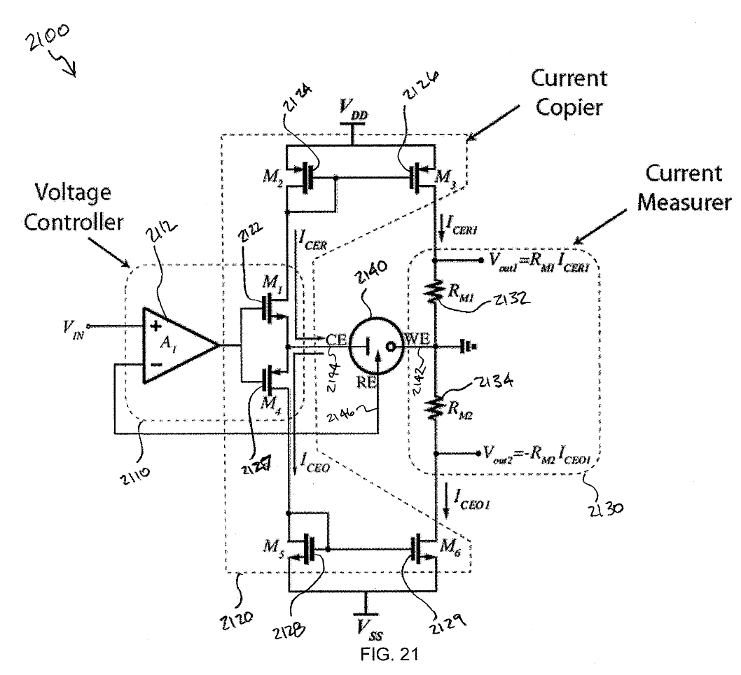

Referring now to FIG. 21, an exemplary potentiostat coupled to electrochemical sensors with oxidation current and electrochemical sensors with reduction current is illustrated according to one embodiment. A potentiostat 2100 includes a voltage controller 2110 having an amplifier 2112, and transistors 2122, 2128. A working electrode 2142 of an electrochemical sensor 2140 is coupled to ground, and a reference electrode 2146 is coupled to the inverting input of the amplifier 2112. The voltage controller 2110 controls the cell potential according to an input voltage, V_{IN}, applied to the non-inverting input of the amplifier 2112. The potentiostat 2100 also includes a current copier 2120 having transistors 2122, 2124, 2126, 2127, 2128, 2129.

If the electrochemical sensor 2140 has a reduction current and is coupled to the potentiostat 2100, the transistor 2122 conveys the current of the counter electrode, I_{CER}, to the current mirror of the transistors 2124, 2126. The transistors 2124, 2126 generate a copied reduction counter electrode current, I_{CER1}, of the counter electrode current, I_{CER}. The copied reduction counter electrode current, I_{CER1}, may be an approximated, amplified or attenuated version of the reduction counter electrode current, I_{CER}. When an electrochemical sensor with reduction current is coupled to the potentiostat 2100, the oxidation counter electrode current, I_{CEO}, is negligible and the transistors 2127, 2128, 2129 are off.

If the electrochemical sensor 2140 has an oxidation current and is coupled to the potentiostat 2100, the transistor 2127 conveys the oxidation counter electrode current, I_{CEO}, to the current mirror of the transistors 2128, 2129. The transistors 2128, 2129 generate a copied oxidation counter electrode current, I_{CEO1}, of the oxidation counter electrode current, I_{CEO}. The copied oxidation counter electrode current, I_{CEO1}, may be approximated, amplified or attenuated version of the oxidation counter electrode current, I_{CEO}. When the electrochemical sensor 2140 with oxidation current is coupled to the potentiostat 2100, the reduction counter electrode current, I_{CER}, is negligible and the transistors 2122, 2124, 2126 are off.

The potentiostat 2100 also includes a current measurer 2130 having resistors 2132, 2134. The current measurer 2130 has two input currents, the copied reduction counter electrode current, I_{CER1}, and the copied oxidation counter electrode current, I_{CEO1}, and two output voltages, Vₒᵤₜ₁ and Vₒᵤₜ₂. The output voltage, Vₒᵤₜ₁, is related to the copied reduction counter electrode current, I_{CER1}, by the equation: Vₒᵤₜ₁=I_{CER1}*R_{M1}. The output voltage, Vₒᵤₜ₂, is related to the copied oxidation counter electrode current, I_{CEO1}, by the equation: Vₒᵤₜ₁=−IFO1*RM2.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A circuit for measuring an electrical current in an electrochemical cell, the circuit comprising:
a voltage controller coupled to said electrochemical cell that controls a voltage difference between at least two electrode of said electrochemical cell;
a current copier that produces a mirrored current of said electrical current, wherein the current copier is coupled to at least one of said voltage controller and said electrochemical cell; and
a current measurer coupled to said current copier that measures said mirrored current.

2. The circuit of claim 1, wherein the current measurer comprises at least one of a resistor, an analog-to-digital converter, a sigma-delta modulator, and a current-to-frequency converter.

3. The circuit of claim 1, further comprising a display for displaying at least one of a measure of said mirrored current and a medically-relevant diagnostic value calculated from said mirrored current.

4. The circuit of claim 1, wherein said current copier is at least one of a cascode current mirror, a regulated cascode current mirror, a Wilson current mirror, and a Widlar current mirror.

5. The circuit of claim 1, wherein said current copier comprises at least one of bipolar-type transistors, complimentary metal-oxide-semiconductor-type transistors, and BiCMOS transistors.

6. The circuit of claim 1, wherein said current copier comprises at least two matched transistors.

7. The circuit of claim 1, wherein said current copier is coupled to a counter electrode of said electrochemical cell and a working electrode of said electrochemical cell is coupled to at least one of ground and a supply voltage.

8. The circuit of claim 1, wherein said current copier is coupled to a working electrode of said electrochemical cell and a counter electrode of said electrochemical cell is coupled to at least one of ground and a supply voltage.

9. The circuit of claim 1, wherein said current copier comprises at least two current mirrors, at least one current mirror for measuring a reduction reaction in said electrochemical cell and at least one current mirror for measuring an oxidation reaction in said electrochemical cell.

10. The circuit of claim 1, further comprising a second current copier coupled between the current copier and the current measurer.

11. The circuit of claim 10, wherein said current copier is coupled to a first supply voltage and said second current copier is coupled to a second supply voltage.

12. The circuit of claim 1, wherein the circuit is integrated into at least one of an integrated circuit, a biochemical sensor, and a glucose sensor.

13. A method for measuring current in an electrochemical cell, the method comprising:
applying a constant potential to a working electrode and a reference electrode of said electrochemical cell to induce an electrical current through said electrochemical cell;
replicating said electrical current to produce a mirrored electrical current; and
measuring said mirrored electrical current.

14. The method of claim 13, further comprising converting said electrical current to at least one of a voltage, a displayed value, an audible signal, a time-modulated signal, a frequency-modulated signal, and an analyte concentration.

15. The method of claim 13, further comprising immersing said electrochemical cell in a solution before applying said constant potential.

16. The method of claim 13, wherein:
said solution comprises blood;
said working electrode of said electrochemical cell comprises platinum;
a counter electrode of said electrochemical cell comprises platinum;
said reference electrode of said electrochemical cell comprises silver;
said mirrored electrical current is proportional to a concentration of hydrogen peroxide; and
change in said concentration of said hydrogen peroxide is proportional to a concentration of glucose in said solution.

17. A potentiostat, comprising:
means for controlling voltage coupled to an electrochemical cell that generates an electrical current through said electrochemical cell; and
means for generating a mirrored current of said electrical current for measurement without disturbing said electrical current.

18. The potentiostat of claim 17, further comprising conversion means for converting said mirrored current into a value.

19. The potentiostat of claim 18, further comprising display means for displaying the value.

20. The potentiostat of claim 17, wherein the potentiostat is integrated into at least one of an integrated circuit, a biochemical sensor, and a glucose sensor.
